(19) United States
(12) Patent Application Publication
(10) Pub. No.: US 2016/0173175 A1
(43) Pub. Date: Jun. 16, 2016

(54) BASE STATION APPARATUS, TERMINAL APPARATUS, WIRELESS COMMUNICATION SYSTEM, AND INTEGRATED CIRCUIT

(71) Applicant: SHARP KABUSHIKI KAISHA, Osaka (JP)

(72) Inventors: Hiromichi TOMEBA, Osaka-shi, Osaka (JP); Takashi ONODERA, Osaka-shi, Osaka (JP); Minoru KUBOTA, Osaka-shi, Osaka (JP)

(73) Assignee: SHARP KABUSHIKI KAISHA, Osaka-shi, Osaka (JP)

(21) Appl. No.: 14/896,977

(22) PCT Filed: Jun. 10, 2014
(86) PCT No.: PCT/JP2014/065362

§ 371 Date: Dec. 9, 2015

(30) Foreign Application Priority Data
Jun. 10, 2013 (JP) 2013-121382

(51) Int. Cl. H04B 7/04; H04W 72/04

(52) U.S. Cl. CPC H04B 7/0456; H04W 72/0406; H04B 7/0452; H04W 88/08

(57) ABSTRACT

Provided are a base station apparatus, a terminal apparatus, a wireless communication system, and an integrated circuit in which the terminal apparatus is able to appropriately combine signals received by a plurality of receive antennas in the wireless communication system for performing nonlinear MU-MIMO transmission. The base station apparatus of the invention has a plurality of antennas, is able to apply nonlinear precoding to data signals addressed to a plurality of terminal apparatuses, and spatially multiplexes and transmit the data signals, and based on the data signals and channel information between the base station apparatus and the terminal apparatuses, searches for a perturbation vector to be added to the data signals, and further calculates a covariance matrix of the signals obtained by adding the perturbation vector to the data signals. The terminal apparatus of the invention detects a desired signal from among the signals transmitted from the base station apparatus, based on the covariance matrix.

### TECHNICAL FIELD

The present invention relates a technique for performing multiple input multiple output transmission.

### BACKGROUND ART

In a wireless communication system, there is a constant demand for increasing a transmission rate so that a variety of broadband information services can be provided. It is possible to achieve an increase in the transmission rate by widening a communication bandwidth, but since an available frequency band is limited, improvement in frequency efficiency is necessary. As a technique by which the frequency efficiency is able to be improved significantly, a multiple input multiple output (MIMO) technique for performing wireless transmission by using a plurality of transmit/receive antennas is attracting attention, and has been put to a practical use, for example, in a cellular system and a wireless LAN system. An amount of improvement in the frequency efficiency by the MIMO technique is proportional to the number of transmit/receive antennas. However, the number of receive antennas that are able to be disposed in a terminal apparatus is limited. Thus, multi user-MIMO (MU-MIMO) in which a plurality of terminal apparatuses connected at the same time are regarded as a large-scale virtual antenna array, and transmission signals from a base station apparatus to each of the terminal apparatuses are spatially multiplexed is effective for improving the frequency efficiency.

In the MU-MIMO, a transmission signal addressed to one terminal apparatus is received as inter-user-interference (IUI) by other terminal apparatuses and it is therefore necessary to suppress the IUI. For example, in Long Term Evolution that is employed as one of 3.9th generation mobile wireless communication systems, linear precoding is used to suppress the IUI by multiplying, in the base station apparatus in advance, linear filters which are calculated based on channel information notified from each of the terminal apparatuses.

For the purpose of further improving the frequency efficiency in the MU-MIMO, nonlinear precoding in which nonlinear processing is performed on the base station apparatus side has attracted attention. In the case where modulo operation is able to be carried out in the terminal apparatuses, the base station apparatus is able to add to a transmission signal a perturbation vector having an element of a complex number (perturbation term) obtained by multiplying a Gaussian integer by a given real number.

Thus, when the base station apparatus appropriately configures a perturbation vector in accordance with a channel state between the base station apparatus and a plurality of terminal apparatuses, necessary transmit power may considerably be reduced in comparison with the linear precoding. As the nonlinear precoding, vector perturbation (VP) described in NPL 1, and Tomlinson Harashima precoding (THP) described in NPL 2 are well known.

Meanwhile, in the case where a terminal apparatus has a plurality of receive antennas in downlink MU-MIMO transmission, the terminal apparatus appropriately combines signals received by the plurality of receive antennas, thus transmission quality being improved. For example, in NPL 3, a receive antenna combining (receive antenna diversity) technique in linear MU-MIMO transmission is discussed. Further, receive antenna diversity in MU-MIMO transmission using the THP is discussed in PTL 1. By applying the receive antenna diversity also to the MU-MIMO transmission using the VP, improvement of transmission performance is expected. The fact is, however, that a receive antenna combining method by which transmission performance of VP MU-MIMO is able to be improved is not disclosed.

### CITATION LIST

### Non Patent Literature

NPL 1: B. M. Hochwald, et. al., “A vector-perturbation technique for near-capacity multiantenna multiuser communication-Part II: Perturbation,” IEEE Trans. Commun., Vol. 53, No. 3, pp. 537-544, March 2005.
NPL 2: M. Joham, et. al., “MMSE approaches to multiuser spatio-temporal Tomlinson-Harashima precoding”, Proc. 5th Int. ITG Conf. on Source and Channel Coding, Erlangen, Germany, January 2004.
NPL 3: IEEE 802.11-09/1234r1, “Interference cancellation for downlink MU-MIMO,” Qualcomm, March 2010.
PTL 1: Japanese Unexamined Patent Application Publication No. 2011-254143

### SUMMARY OF INVENTION

### Technical Problem

The receive antenna combining technique which has been studied conventionally is difficult to be applied to VP MU-MIMO. This is because statistical properties of transmission signals in linear MU-MIMO and THP MU-MIMO which have been studied conventionally are different from statistical properties of transmission signals in VP MU-MIMO.

The invention has been made in view of such circumstances, and an object thereof is to provide a base station apparatus, a terminal apparatus, a wireless communication system, and an integrated circuit capable of improving transmission quality by a terminal apparatus including a plurality of receive antennas appropriately combining signals, which are received by the respective receive antennas, in a radio communication system in which a base station apparatus performs MU-MIMO transmission based on nonlinear precoding, in particular, VP.

### Solution to Problem

(1) In order to achieve the aforementioned object, the invention takes means as follows. That is, a base station apparatus of the invention is a base station apparatus that includes a plurality of antennas, applies nonlinear precoding to a plurality of data signals addressed to at least one terminal apparatus, and spatially multiplexes and transmits the data signals. The base station apparatus includes: a channel information acquisition unit that acquires channel information between the base station apparatus and the terminal apparatus; a mapping unit that multiplexes the plurality of data signals addressed to the terminal apparatus, a reference signal used for channel estimation, and a reference signal used for demodulation; and a precoding unit that applies nonlinear precoding to the plurality of data signals based on the channel information, in which the precoding unit includes a perturbation vector search unit that searches for a perturbation vector, which is to be added to the plurality of data signals, based on the channel information and the plurality of data signals, and a correlation matrix generation unit that calculates a covariance matrix of the plurality of data signals to which the perturbation vector is added.

Such a base station apparatus is able to perform the nonlinear precoding for adding the perturbation vector, which is searched for by the perturbation vector search unit, on the plurality of data signals addressed to at least one terminal apparatus, and calculate the covariance matrix of the data signals to which the perturbation vector is added. Accordingly, the base station apparatus is able to calculate information required for combining the signals received by a plurality of receive antennas by the terminal apparatus, thus making it possible to contribute to improvement in transmission quality.

(2) The base station apparatus of the invention is the base station apparatus according to (1) above, in which the correlation matrix generation unit calculates the covariance matrix based on the channel information.

Such a base station apparatus is able to calculate the covariance matrix based on the channel information, thus making it possible to calculate, with high accuracy, information required for combining the signals received by the plurality of receive antennas by the terminal apparatus.

(3) The base station apparatus of the invention is the base station apparatus according to (2) above, further including a control information multiplexing unit that multiplexes control information associated with the covariance matrix with a signal to be notified to the terminal apparatus, in which the control information multiplexing unit multiplexes the control information with a control channel by which individual control information addressed to the terminal apparatus is notified.

Such a base station apparatus is able to notify the control information associated with the covariance matrix by using the control channel by which the individual control information addressed to the terminal apparatus is notified, so that the base station apparatus is able to efficiently notify the terminal apparatus of the control information associated with the covariance matrix.

(4) The base station apparatus of the invention is the base station apparatus according to (2) above, further including a control information multiplexing unit that multiplexes control information associated with the covariance matrix with a signal to be notified to the terminal apparatus, in which the control information multiplexing unit multiplexes the control information with a control channel by which common control information addressed to a plurality of terminal apparatuses is notified.

Such a base station apparatus is able to notify the control information associated with the covariance matrix by using the control channel by which the common control information addressed to the plurality of terminal apparatuses is notified, so that the base station apparatus is able to efficiently notify the terminal apparatus of the control information associated with the covariance matrix.

(5) The base station apparatus of the invention is the base station apparatus according to (2) above, in which the precoding unit applies a part of processing of the nonlinear precoding to the reference signal used for demodulation, based on the covariance matrix.

Such a base station apparatus is able to implicitly notify the terminal apparatus of the control information associated with the covariance matrix, by using the reference signal used for demodulation, thus making it possible to suppress overhead associated with the notification of the control information.

(6) The base station apparatus of the invention is the base station apparatus according to (5) above, in which the precoding unit applies the precoding to the plurality of data signals based on the covariance matrix.

Such a base station apparatus is able to reflect the control information associated with the covariance matrix also in the plurality of data signals in addition to the reference signal used for demodulation, thus making it possible to suppress overhead associated with the transmission of the reference signal used for demodulation.

(7) A terminal apparatus of the invention is a terminal apparatus that receives by a plurality of antennas a plurality of data signals, which are subjected to nonlinear precoding, spatially multiplexed, and transmitted from a base station apparatus. The terminal apparatus includes: a channel estimation unit that acquires channel information between the terminal apparatus and the base station apparatus; a feedback information generation unit that generates control information associated with the channel information; and a channel equalization unit that performs antenna combining by multiplying the signals received by the plurality of antennas by a liner filter, in which the channel equalization unit calculates the linear filter based on a covariance matrix of the plurality of data signals, to which a part of processing of the nonlinear precoding is applied, and the channel information.

Such a terminal apparatus is able to efficiently combine the signals, which have received by the plurality of receive antennas, based on the covariance matrix, thus making it possible to improve transmission quality and further contribute to improvement in frequency efficiency.

(8) The terminal apparatus of the invention is the terminal apparatus according to (7) above, further including a control information separation unit that acquires control information associated with the covariance matrix from the signals transmitted from the base station apparatus.

Such a terminal apparatus is able to acquire the covariance matrix from the control information associated with the covariance matrix. Accordingly, it is possible to efficiently combine the signals received by the plurality of receive antennas, thus making it possible to improve transmission quality and further contribute to improvement in frequency efficiency.

(9) The terminal apparatus of the invention is the terminal apparatus according to (7) above, in which the channel estimation unit estimates equalization channel information between the terminal apparatus and the base station apparatus, which includes information about the nonlinear precoding and the covariance matrix, based on a reference signal used for demodulation transmitted from the base station apparatus, and the channel equalization unit calculates the linear filter based on the equalization channel information.

Such a terminal apparatus is able to acquire the information about the covariance matrix based on the reference signal used for demodulation transmitted from the base station apparatus, thus making it possible to suppress overhead associated with the notification of the control information.

(10) A wireless communication system of the invention includes the base station apparatus according to (1) above and at least one terminal apparatus according to (7) above.

In such a wireless communication system, the base station apparatus is able to perform the nonlinear precoding for adding the perturbation vector which is searched for by the perturbation vector search unit on the plurality of data signals addressed to at least one terminal apparatus, and calculate the covariance matrix of the data signals to which the perturbation vector is added. Further, the terminal apparatus is able to efficiently combine the signals, which have been received by the plurality of receive antennas, based on the covariance matrix, thus making it possible to improve transmission quality and further contribute to improvement in frequency efficiency.

(11) An integrated circuit of the invention is an integrated circuit that is mounted in a base station apparatus, which includes a plurality of antennas, applies nonlinear precoding to a plurality of data signals addressed to at least one terminal apparatus, and spatially multiplexes and transmit the data signals, and that causes the base station apparatus to exert a plurality of functions, the functions including a function of acquiring channel information between the base station apparatus and the terminal apparatus; a function of multiplexing the plurality of data signals addressed to the terminal apparatus, a reference signal used for channel estimation, and a reference signal used for demodulation; and a function of applying precoding to the plurality of data signals based on the channel information, in which, with the function of applying the precoding, a perturbation vector, which is to be added to the plurality of data signals, is searched for based on the channel information and the plurality of data signals, and a covariance matrix of the plurality of data signals to which the perturbation vector is added is calculated.

With such an integrated circuit, the base station apparatus is able to perform the nonlinear precoding for adding the perturbation vector which is searched for by the perturbation vector search unit to the plurality of data signals addressed to at least one terminal apparatus, and calculate the covariance matrix of the data signals to which the perturbation vector is added. Accordingly, the base station apparatus is able to calculate information required for combining the signals received by the plurality of receive antennas by the terminal apparatus, thus making it possible to contribute to improvement in transmission quality.

(12) An integrated circuit of the invention is an integrated circuit that is mounted in a terminal apparatus that receives a plurality of data signals, which are subjected to nonlinear precoding, spatially multiplexed, and transmitted from a base station apparatus, by a plurality of antennas, and that causes the terminal apparatus to exert a plurality of functions, the functions including: a function of acquiring channel information between the terminal apparatus and the base station apparatus; a function of generating control information associated with the channel information; and a function of performing antenna combining by multiplying by a liner filter the signals received by the plurality of antennas, in which, with the function of performing the antenna combining, a plurality of data signals addressed to the terminal apparatus are detected based on a covariance matrix of the plurality of data signals to which a part of processing of the nonlinear precoding is applied, and the channel information.

With such an integrated circuit, the terminal apparatus is able to efficiently combine the signals, which have been received by the plurality of receive antennas, based on the covariance matrix, thus making it possible to improve transmission quality and further contribute to improvement in frequency efficiency.

### Advantageous Effects of Invention

According to the invention, in a wireless communication system composed of a base station apparatus which generates transmission signals based on nonlinear precoding, in particular, VP, and a terminal apparatus which includes a plurality of receive antennas, the terminal apparatus appropriately combines signals received by the plurality of receive antennas, so that it is possible to improve transmission quality, and further to contribute to significant improvement in frequency efficiency of the wireless communication system.

### BRIEF DESCRIPTION OF DRAWINGS

FIG. 1 is an illustration of one schematic example of a wireless communication system according to a first embodiment of the invention.

FIG. 2 is a block diagram illustrating one configuration example of a base station apparatus according to the first embodiment of the invention.

FIG. 3 is a block diagram illustrating one configuration example of a transmission frame according to the first embodiment of the invention.

FIG. 4 is a block diagram illustrating one configuration example of a precoding unit 27 according to the first embodiment of the invention.

FIG. 5 is a block diagram illustrating one configuration example of an antenna unit 29 according to the first embodiment of the invention.

FIG. 6 is a block diagram illustrating one configuration example of a terminal apparatus 2 according to the first embodiment of the invention.

FIG. 7 is a block diagram illustrating one configuration example of a terminal antenna unit 51 according to the first embodiment of the invention.

FIG. 8 is an illustration of one schematic example of a wireless communication system according to a second embodiment and a third embodiment of the invention.

FIG. 9 is a block diagram illustrating one configuration example of a base station apparatus according to the second embodiment and the third embodiment of the invention.

FIG. 10 is a diagram illustrating one configuration example of a precoding unit 27b according to the second embodiment of the invention.

FIG. 11 is a block diagram illustrating one configuration example of a terminal apparatus 2b and a terminal apparatus 2c according to the second embodiment and the third embodiment of the invention, respectively.

FIG. 12 is a diagram illustrating one configuration example of a precoding unit 27c according to the third embodiment of the invention.

FIG. 13 is a block diagram illustrating one configuration example of a terminal antenna unit 51c according to the third embodiment of the invention.

FIG. 14 is a block diagram illustrating one configuration example of a precoding unit 27d according to a modified example 1 of the third embodiment of the invention.

### DESCRIPTION OF EMBODIMENTS

Embodiments in the case where a wireless communication system of the invention is applied will be described below with reference to drawings. Note that, items described in the present embodiments are merely one aspect for understanding the invention, and the content of the invention is not to be interpreted as limited to the embodiments. Unless otherwise noted, hereinafter, A^{T} denotes a transposed matrix of a matrix A, A^{H} denotes an adjugate (Hermitian transpose) matrix of the matrix A, A⁻¹ denotes an inverse matrix of the matrix A, diag (A) denotes a diagonal matrix in which only diagonal components are extracted from the matrix A or a diagonal matrix having elements within brackets arranged in diagonal components, I_{N} denotes a unit matrix with N rows and N columns, O_{N} denotes a zero matrix with N rows and N columns, floor (c) denotes a floor function that returns a maximum Gaussian integer whose real part and imaginary part do not exceed values of a real part and an imaginary part of a complex number c, E[x] denotes an ensemble average of a random variable x, and denotes a norm of a vector a. Moreover, [A, B] denotes ∥a∥ matrix in which matrixes A and B are coupled in a column direction. Z[i] denotes a set of all Gaussian integers. Note that, the Gaussian integer is a complex number whose real part and imaginary part are respectively represented by integers.

### 1. First Embodiment

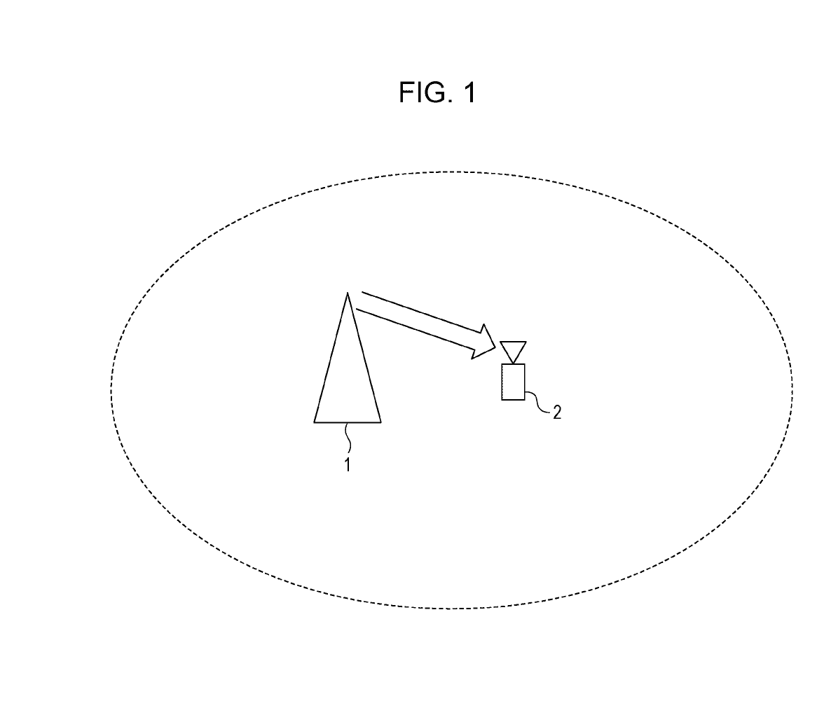

FIG. 1 is an illustration of one schematic example of a wireless communication system according to a first embodiment of the invention. The first embodiment is intended for single user-MIMO (SU-MIMO) transmission in which one terminal apparatus 2 (also called a wireless reception apparatus) which has Nᵣ receive antennas is connected to a base station apparatus 1 (also called a wireless transmission apparatus) which has Nₜ transmit antennas and is capable of performing nonlinear precoding. R(<Nᵣ) pieces of data are simultaneously transmitted to the terminal apparatus 2. Note that, the number of pieces of data to be simultaneously transmitted is also called rank.

In the present embodiment, it is assumed that narrow-band single-carrier transmission is provided. However, there is no limitation to a transmission method which is intended for in the present embodiment. For example, the embodiment is applicable to orthogonal frequency division multiplexing (OFDM) signal transmission having a plurality of sub-carriers, and a multiplexing access method (OFDMA) based on the OFDM. In this case, signal processing performed by the base station apparatus 1 and the terminal apparatus 2 in the present embodiment may be performed for each sub-carrier or may be performed for each resource block (or sub-band) formed of a plurality of sub-carriers and OFDM signals.

The base station apparatus 1 acquires channel information (also called CSI (channel state information)) from the base station apparatus 1 to the terminal apparatus 2 based on control information notified from the terminal apparatus 2. The base station apparatus 1 then performs precoding on transmission data based on the acquired channel information. It is assumed below that a duplexing method is frequency division duplexing, but time division duplexing is also included in the present embodiment.

The CSI between the base station apparatus 1 and the terminal apparatus 2 will be described. In the present embodiment, it is assumed a block fading channel is provided. When complex channel gains between an n-th transmit antenna (n=1 to Nₜ) and an m-th receive antenna (m=1 to Nᵣ) of a u-th terminal apparatus 2-u (u=1 to U) are h_{u,m,n}, a channel matrix hᵤ is defined as a formula (1).

$$\begin{matrix}[ Expression 1 ] & \\ {h}_{u} = ( \begin{matrix}{h}_{u , 1 , 1} & … & {h}_{u , 1 , {N}_{t}} \\ ⋮ & ⋱ & ⋮ \\ {h}_{u , {N}_{r} , 1} & … & {h}_{u , {N}_{r} , {N}_{t}}\end{matrix} ) & ( 1 )\end{matrix}$$

Since one terminal apparatus 2 is connected to the base station apparatus 1 in the present embodiment, a subscript u indicating a number of the terminal apparatus will be omitted to be described below for simplification. Unless otherwise noted, the CSI refers to a matrix formed of complex channel gains in the present embodiment. However, it is also possible to perform signal processing described below by regarding a spatial correlation matrix or a matrix in which linear filters described in a code book, which is shared in advance between the base station apparatus 1 and the terminal apparatus 2, are arrayed, as the CSI. In the case where a unique vector or a unique value obtained by applying singular value decomposition (or unique value decomposition) to a channel matrix estimated by the terminal apparatus 2 is notified to the base station apparatus 1, the base station apparatus 1 may regard the unique vector itself or a matrix in which vectors obtained by multiplying the unique vector by the unique value are arrayed, as the CSI.

Here, the CSI which is actually notified by the terminal apparatus 2 to the base station apparatus 1 is defined as h_{FB}. The terminal apparatus 2 feedbacks the CSI according to the number of transmission streams (rank) which are actually transmitted by the base station apparatus 1. Since the rank is assumed as R in the present embodiment, the terminal apparatus 2 needs to feedback R pieces of CSI. Here, one piece of CSI refers to a vector formed of complex channel gains between the plurality of transmit antennas included in the base station apparatus 1 and one receive antenna among the plurality of receive antennas included in the terminal apparatus 2 or one vector among a plurality of unique vectors calculated at the terminal apparatus 2.

In the present embodiment, a type and a selection method of the R pieces of CSI are not limited. For example, the terminal apparatus 2 may merely notify the base station apparatus 1 of complex channel gains observed by R receive antennas among the Nᵣ receive antennas. At this time, h_{FB} notified by the terminal apparatus 2 is a channel matrix of R×Nₜ.

The terminal apparatus 2 may notify the base station apparatus of R unique vectors from among a plurality of unique vectors obtained by applying singular value decomposition (or unique value decomposition) to a channel matrix h. At this time, the terminal apparatus 2 may notify unique values, which correspond to the unique vectors to be notified, together.

The terminal apparatus 2 is able to randomly select the R receive antennas or the R unique vectors to notify to the base station apparatus 1. Alternatively, the terminal apparatus 2 may select the R pieces in descending order of an average gain from among the complex channel gains observed by the Nᵣ receive antennas. Further, the terminal apparatus 2 may select the complex channel gains observed by the R receive antennas which have a low spatial correlation to each other. The terminal apparatus 2 may notify unique vectors corresponding to the R unique values in descending order from among the plurality of unique values.

In the following, the terminal apparatus 2 directly quantizes the complex channel gains observed by the R receive antennas which are randomly selected from the Nᵣ receive antennas to notify the result to the base station apparatus 1. That is, h_{FB} is the channel matrix of R×Nₜ. At this time, an error may occur between actual complex channel gains and h_{FB} depending on the number of quantization bits, which causes deterioration in performance also in a method of the present embodiment described below. However, the signal processing of the present embodiment is not affected by magnitude of the error, so that description or explanation for the error between the actual complex channel gains and h_{FB} will be omitted in the following description.

Note that, the method of the invention is also applicable to a wireless communication system in which time division duplexing is employed as a duplexing method. In this case, the base station apparatus 1 is able to acquire CSI based on signals transmitted in uplink from the terminal apparatus 2. Of course, similarly to a wireless communication system in which frequency division duplexing is employed, the base station apparatus 1 may acquire CSI by feedback from the terminal apparatus 2.

[1.1 Base Station Apparatus 1]

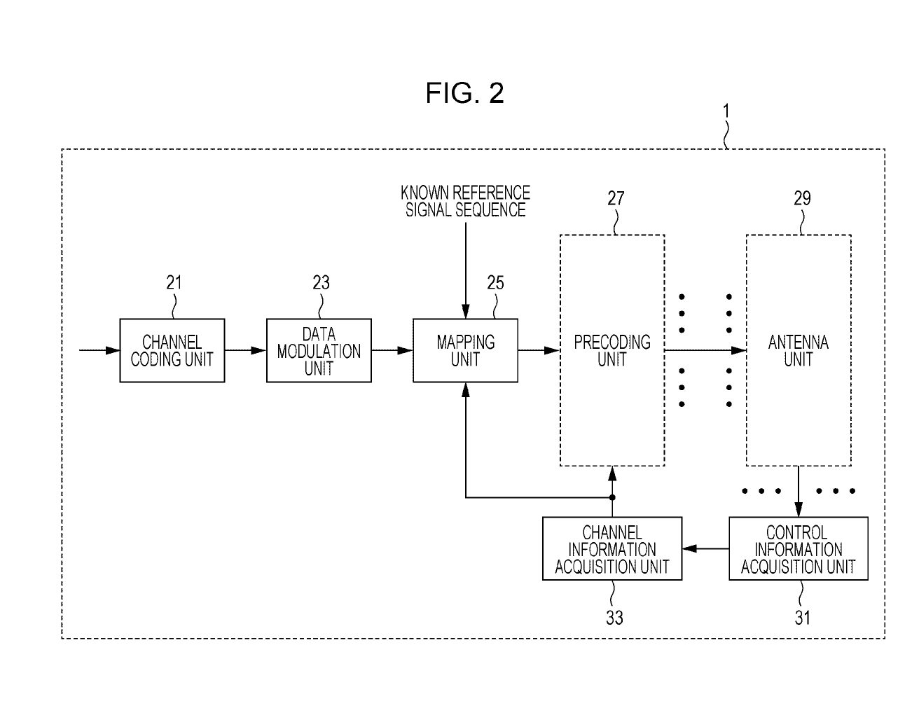

FIG. 2 is a block diagram illustrating one configuration example of the base station apparatus 1 according to the first embodiment of the invention. As illustrated in FIG. 2, the base station apparatus 1 is composed by including a channel coding unit 21, a data modulation unit 23, a mapping unit 25, a precoding unit 27, antenna units 29, a control information acquisition unit 31, and a channel information acquisition unit 33. The base station apparatus 1 includes the antenna units 29 by the number Nₜ of the transmit antennas.

The control information acquisition unit 31 acquires control information notified from the terminal apparatus 2 which is connected, and outputs information, which is associated with CSI, among the control information to the channel information acquisition unit 33. Based on the information input from the control information acquisition unit 31 and a type of an information format used for notifying the CSI by the terminal apparatus 2, the channel information acquisition unit 33 calculates h_{FB} notified from the terminal apparatus 2. The channel information acquisition unit 33 outputs the calculated h_{FB} to the precoding unit 27.

The channel coding unit 21 performs channel coding on a transmission data sequence addressed to the terminal apparatus 2 and inputs the result to the data modulation unit 23.

The data modulation unit 23 applies digital data modulation, such as QPSK (Quadrature Phase Shift Keying), or 16QAM (Quadrature Amplitude Modulation), to a bit sequence input by the channel coding unit 21 and inputs the result to the mapping unit 25.

The mapping unit 25 performs mapping (also referred to as scheduling or resource allocation) for arranging input signals in a designated radio resource (also referred to as a resource element or simply a resource). Here, the radio resource mainly refers to a frequency, a time, a code, and a space. The radio resource to be used is determined based on reception quality observed in the terminal apparatus 2, an accumulation amount of data addressed to the terminal apparatus 2, and the like. In the present embodiment, the radio resource to be used is defined in advance and is able to be recognized by both of the base station apparatus 1 and the terminal apparatus 2. Note that, the mapping unit 25 also multiplexes a known reference signal sequence for performing channel estimation in the terminal apparatus 2.

The base station apparatus 1 transmits, to the terminal apparatus 2, two types of reference signals of CSI-Reference Signals (CSI-RSs) which are reference signals used for channel estimation and Demodulation Reference Signals (DMRSs) which are reference signals used for demodulation (also called unique reference signals), but may further transmit other reference signals. Since the CSI-RSs are used by the terminal apparatus 2 to estimate the CSI (that is, h) observed by the terminal apparatus 2, the base station apparatus 1 needs to transmit the CSI-RSs to be transmitted from each of the transmit antennas, by radio resources which are orthogonal to one another.

The DMRSs are signals used by the terminal apparatus 2 to estimate channel information in which a result of precoding described below is reflected. Since the DMRSs are associated with respective R pieces of data subjected to precoding, the base station apparatus 1 needs to transmit at least R DMRSs by radio resources which are orthogonal to one another. The mapping unit 25 performs mapping so as to transmit data signals, the DMRSs, and the CSI-RSs with different times or codes.

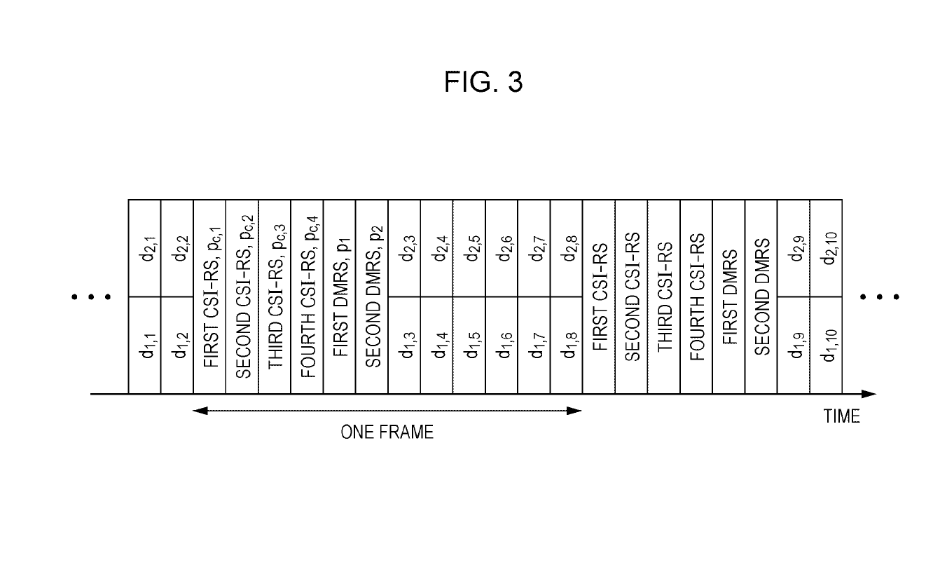

FIG. 3 is a view illustrating one example of mapping applied by the mapping unit 25 in the first embodiment. Here, it is assumed that Nₜ=4 and R=2. d_{m,t} denotes an m-th data signal among the R pieces of data, which are spatially multiplexed and simultaneously transmitted by the base station apparatus 1 to the terminal apparatus 2 at a time of t. denotes a CSI-RS which is transmitted by the base station apparatus 1 from an n-th transmit antenna. pₘ is a DMRS associated with d_{m,t} and is transmitted being applied with a part of precoding applied to d_{m,t}, which will be described below in detail. A time index t will be omitted to be described below except for a case to be particularly noted. The mapping unit 25 inputs the data signals and the like, which have been mapped, to the precoding unit 27.

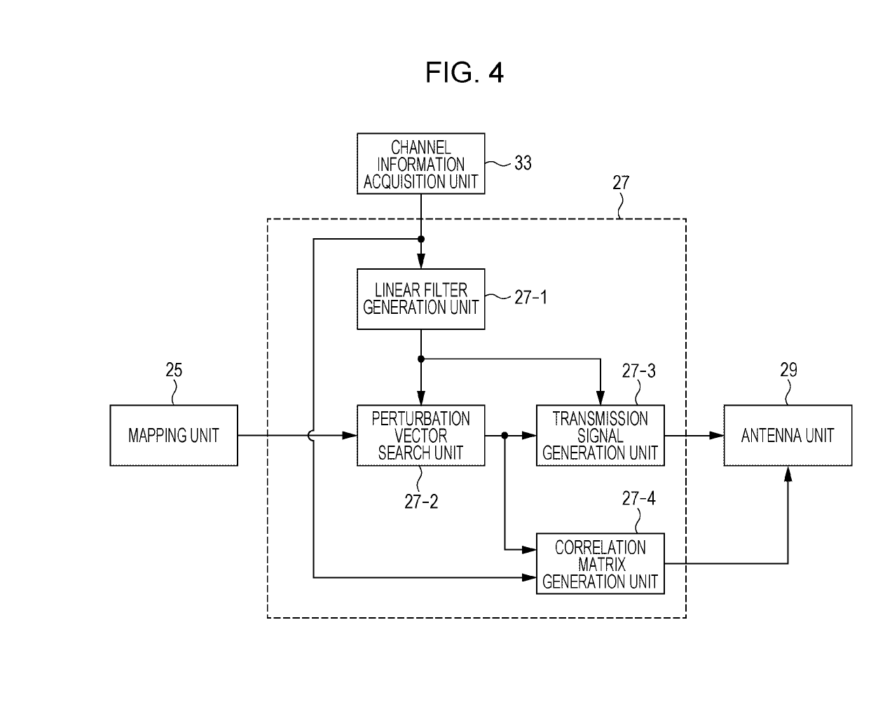

FIG. 4 is a block diagram illustrating one example of a device configuration of the precoding unit 27 according to the first embodiment of the invention. As illustrated in FIG. 4, the precoding unit 27 is composed by including a linear filter generation unit 27-1, a perturbation vector search unit 27-2, a transmission signal generation unit 27-3, and a correlation matrix generation unit 27-4. Note that, description will be given below only for signal processing for the data signals and the DMRSs among the signals input to the precoding unit 27. The precoding unit 27 does not perform precoding based on channel information and performs only transmit power control for the CSI-RSs, so that the description thereof will be omitted.

Signal processing of the data signals, which is applied by the precoding unit 27, will be described. The linear filter generation unit 27-1 generates a linear filter W based on channel information h_{FB} input from the channel information acquisition unit 33. In the present embodiment, the linear filter generation unit 27-1 generates the liner filter W based on a minimum mean square error (MMSE) criterion which minimizes a mean square error between a data signal vector d=[d₁, . . . , d_{R}]^{T} transmitted by the base station apparatus 1 and a soft-estimation value vector of the data signal vector d, which is detected by the terminal apparatus 2. The linear filter generation unit 27-1 outputs the generated linear filter W to the perturbation vector search unit 27-2 and the correlation matrix generation unit 27-4.

The liner filter W is given by W=h_{FB}^{H}(h_{FB}h_{FB}^{H}+αI_{R})¹. Here, α is an adjustment term determined according to inter-antenna interference (also called inter-stream interference) IAI observed in the terminal apparatus 2. With α=0, the linear filter generation unit 27-1 is able to suppress the IAI completely. When a is set to an extremely large value (for example, such as 10¹⁰), the linear filter generation unit 27-1 highlights the IAI, but is able to increase a reception signal to noise ratio (SNR), which is measured in the terminal apparatus 2. Normally, by configuring the value of α to an inverse of the reception SNR, which is observed in the terminal apparatus 2, the linear filter generation unit 27-1 is able to realize high transmission performance. Of course, a may be designed by computer simulation assuming an actual environment, actual transmission experiments, and the like.

When the base station apparatus 1 transmits, instead of data signal vector d addressed to the terminal apparatus 2, Wd obtained by multiplying d by the linear filter W, reception quality of the terminal apparatus 2 is able to be improved. On the other hand, transmit power available to the base station apparatus 1 is limited. Power of Wd fluctuates depending on a state of h_{FB}. Accordingly, the precoding unit 27 needs to apply power normalization by which average transmit power of Wd becomes constant. Therefore, the reception SNR measured in the terminal apparatus 2 is reduced by the power normalization depending on the state of h_{FB}.

The precoding unit 27 of the present embodiment adds a perturbation vector to d to thereby avoid the reduction in the reception SNR associated with the power normalization. The perturbation vector is calculated in the perturbation vector search unit 27-2. To the perturbation vector search unit 27-2, W is input from the linear filter generation unit 27-1 and the data signal vector d addressed to the terminal apparatus 2 is input from the mapping unit 25.

A perturbation vector z is given by z=[z₁, . . . , z_{R}]^{T}, and {zₘ; m=1 to R} denotes perturbation terms added to dₘ. The perturbation terms are provided by any Gaussian integers. The perturbation vector search unit 27-2 searches for the perturbation vector z by solving a minimization problem given by a formula (2).

$$\begin{matrix}[ Expression 2 ] & \\ z = {arg min}_{{z}_{1} , … , {z}_{R} ∈ Z [ i ]} ( ( {( d + 2 δ z )}^{H} {( {h}_{FB} {h}_{FB}^{H} + α {I}_{R} )}^{- 1} ( d + 2 δ z ) ) ) & ( 2 )\end{matrix}$$

Here, δ is called a modulo width and is a real number which is determined in accordance with a modulation method used by the data modulation unit 23. For example, in the case where QPSK as the modulation method is applied to dₘ, δ=2^{1/2} may be set. However, a value of the modulo width may be configured to any value as long as being shared between the base station apparatus 1 and the terminal apparatus 2. In addition, a common value may be used in all modulation methods. Values obtained by multiplying z and zₘ by 2δ are also called a perturbation vector and a perturbation term, respectively below.

The minimization problem given by the formula (2) is based on the criterion which minimizes a mean square error between the data signal vector d and a data signal vector to be demodulated in the terminal apparatus 2. The perturbation vector search unit 27-2 may search for a perturbation vector based not on the criterion for minimizing a mean square error but on a criterion for minimizing transmit power.

Since the perturbation terms which form the perturbation vector are given by any Gaussian integers, it is not realistic to search all combinations of perturbation terms. Thus, the perturbation vector search unit 27-2 of the present embodiment searches for the perturbation vector which satisfies the formula (2) by using a technique for reducing an amount of operation, such as Sphere encoding or QRM-VP.

The perturbation vector search unit 27-2 adds the perturbation vector z calculated based on the formula (2) to the data signal vector d to thereby calculate a transmission code vector x=d+2δz. The perturbation vector search unit 27-2 outputs the transmission code vector x to the transmission signal generation unit 27-3 and the correlation matrix generation unit 27-4.

The channel information h_{FB} and the transmission code vector x are input to the correlation matrix generation unit 27-4. The correlation matrix generation unit 27-4 obtains a covariance matrix Pₓ=E[xx^{H}] of the transmission code vector x calculated by the perturbation vector search unit 27-2. The correlation matrix generation unit 27-4 is able to directly obtain Pₓ=E[xx^{H}] based on the transmission code vector x in each radio resource. In this case, the correlation matrix generation unit 27-4 may obtain xx^{H} from the transmission code vectors x of given numbers of radio resources (such as in a frame unit) and take an average thereof.

In addition, in the case where the perturbation vector search unit 27-2 searches for the perturbation vector z based on the minimization problem given by the formula (2), the correlation matrix generation unit 27-4 may obtain the covariance matrix, for example, with Pₓ=β⁻¹(h_{FB}h_{FB}^{H}+αI_{R}). This is because, in the case where the perturbation vector search unit 27-2 searches for the perturbation vector z based on the minimization problem given by the formula (2), a value obtained when the searched perturbation vector is input to an evaluation function of the minimization problem is defined to be an almost fixed value regardless of a channel state. This is more noticeable when the number of transmission streams or the number of transmit antennas is large. Note that, β is a power normalization coefficient described below and has a fixed value, and may be therefore calculated with β⁻¹=1. The correlation matrix generation unit 27-4 obtains the covariance matrix Pₓ of the transmission code vector to output the result to the antenna unit 29.

The transmission signal generation unit 27-3 calculates a transmission signal vector s=βWx based on the transmission code vector x input from the perturbation vector search unit 27-2 and the linear filter W input from the linear filter generation unit 27-1. Here, β is a power normalization term which makes an average transmit power of the transmission signal vector s fixed. The transmission signal generation unit 27-3 calculates β so that the average power of s and the average power of d become equal. Note that, in the case where transmit power by which the base station apparatus 1 is allowed to transmit a signal is defined in advance, the transmission signal generation unit 27-3 may configure β so that the transmit power of s becomes equal to or lower than the transmit power allowed by the base station apparatus 1.

The transmission signal generation unit 27-3 may perform power normalization so that the average transmit power is fixed for each of a plurality of radio resources. For example, the transmission signal generation unit 27-3 may perform power normalization so that the transmit power in a unit of a radio frame provided as illustrated in FIG. 3 is fixed. In the case where the method of the present embodiment is applied to multicarrier transmission such as OFDM transmission, the transmission signal generation unit 27-3 is able to perform power normalization for each of a plurality of sub-carriers or for each of OFDM symbols. This is similarly applied to a case where the method of the present embodiment is applied to a single carrier-based wireless access method such as an SC-FDMA.

The transmission signal vector s calculated by the transmission signal generation unit 27-3 is a column vector having Nₜ elements, and an n-th element is to be transmitted by an n-th transmit antenna included in the base station apparatus 1. The transmission signal generation unit 27-3 outputs each of the elements of the calculated transmission signal vector s to the corresponding antenna unit 29.

Next, signal processing in the case where DMRSs are input to the precoding unit 27 will be described. As illustrated in a frame configuration of FIG. 3, the base station apparatus 1 in the present embodiment transmits the DMRSs by using radio resources which are orthogonal to one another. That is, the base station apparatus 1 does not perform spatial multiplexing on the DMRSs. Thus, the precoding unit 27 does not perform searching nor addition of a perturbation vector in the perturbation vector search unit 27-2 for the input DMRSs.

The transmission signal generation unit 27-3 multiplies the DMRSs by the liner filter W generated in the liner filter generation unit 27-1. For example, pₘ which is an m-th DMRS is multiplied by a vector in an m-th column of W. The transmission signal generation unit 27-3 then performs power normalization on the DMRSs multiplied by the linear filter W and outputs each of them to the corresponding antenna unit 29. Since the terminal apparatus 2 performs demodulation processing for the received data signals based on the corresponding DMRSs (for example, the DMRSs in the same frame), the transmission signal generation unit 27-3 is desired to multiply the DMRSs and the corresponding data signals by the same power normalization term. Of course, the base station apparatus 1 may provide different transmit power to the DMRS and the corresponding data signal, but a power difference thereof is desired to be shared between the base station apparatus 1 and the terminal apparatus 2 mutually. Note that, the transmission signal generation unit 27-3 may perform power normalization for the DMRSs collectively with the data signals. For example, the transmission signal generation unit 27-3 may perform power normalization for each frame as illustrated in FIG. 3.

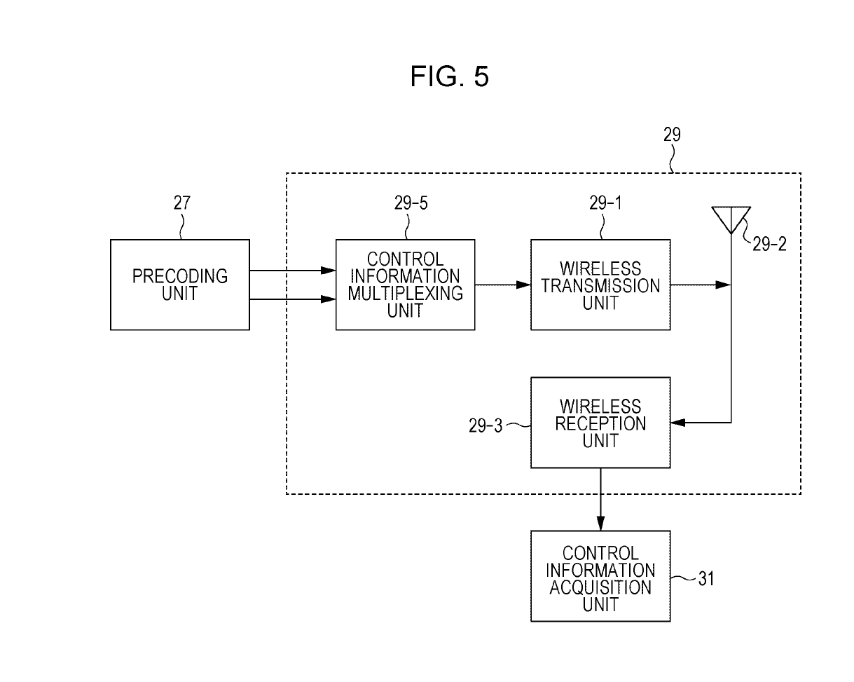

FIG. 5 is a block diagram illustrating one example of a device configuration of the antenna unit 29 according to the first embodiment of the invention. As illustrated in FIG. 5, the antenna unit 29 is composed by including a wireless transmission unit 29-1, an antenna 29-2, a wireless reception unit 29-3, and a control information multiplexing unit 29-5. First, the control information multiplexing unit 29-5 multiplexes the transmission signal vector s and the covariance matrix Pₓ received from the precoding unit 27.

A method of multiplexing in the control information multiplexing unit 29-5 is not limited. For example, the control information multiplexing unit 29-5 may multiplex the transmission signal vector s and the covariance matrix Pₓ so as to be transmitted in radio resources which are orthogonal to one another. In this case, the control information multiplexing unit 29-5 may directly apply quantization to the covariance matrix Pₓ, and apply modulation thereto as appropriate to transmit the result to the terminal apparatus 2.

In the case where the base station apparatus 1 has a configuration to transmit different control information by a different channel in order to notify the terminal apparatus 2 of a modulation method, a coding rate, and the like, information associated with the covariance matrix Pₓ may be notified as a part of the control information. The information associated with the covariance matrix Pₓ may be information obtained by directly quantizing the covariance matrix Pₓ as described above. In a case of a configuration in which a code book in which a plurality of linear filters are described is shared between the base station apparatus 1 and the terminal apparatus 2, the control information multiplexing unit 29-5 may be configured to notify the terminal apparatus 2 of information indicating the linear filter which is most similar to respective column vectors (or row vectors) forming the covariance matrix Pₓ among the plurality of linear filters described in the code book, as the information associated with the covariance matrix P.

In the case where a plurality of terminal apparatuses 2 are connected to the base station apparatus 1, the base station apparatus 1 notifies each terminal apparatus 2 of control information unique to the terminal apparatus 2 and control information common to the plurality of terminal apparatuses 2 by using mutually different control channels in some cases. At this time, the base station apparatus 1 of the present embodiment may notify the information associated with Pₓ by using any control channel.

The control information multiplexing unit 29-5 outputs the signal obtained by multiplexing the transmission signal vector s and the covariance matrix Pₓ to the wireless transmission unit 29-1. The wireless transmission unit 29-1 converts the input transmission signal with a baseband into a transmission signal with a radio frequency (RF) band to input the result to the antenna 29-2. The antenna 29-2 transmits the input transmission signal with the RF band.

On the other hand, signals transmitted from the terminal apparatus 2 to the base station apparatus 1 are input to the wireless reception unit 29-3. In the wireless reception unit 29-3, processing for demodulating the received signals is performed, and a signal associated with the control information among them is output to the control information acquisition unit 31.

### [1.2 Terminal Apparatus 2]

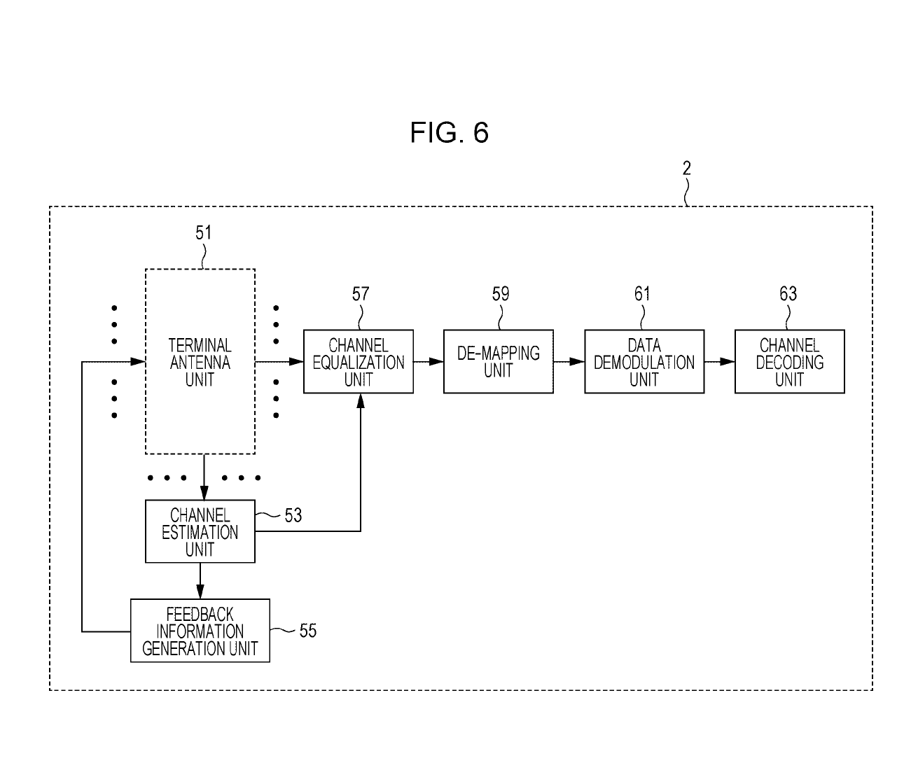

FIG. 6 is a block diagram illustrating one configuration example of the terminal apparatus 2 according to the first embodiment of the invention. As illustrated in FIG. 6, the terminal apparatus 2 is composed by including terminal antenna units 51, a channel estimation unit 53, a feedback information generation unit 55, a channel equalization unit 57, a de-mapping unit 59, a data demodulation unit 61, and a channel decoding unit 63. The terminal apparatus 2 includes the terminal antenna units 51 by the number Nᵣ of the receive antennas.

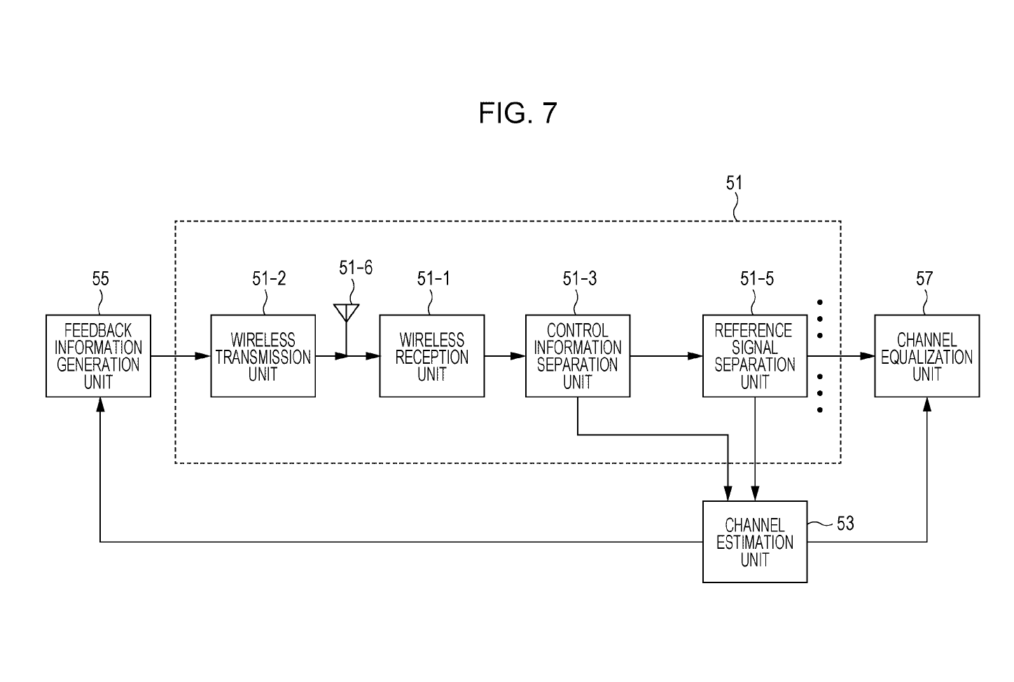

FIG. 7 is a block diagram illustrating one configuration example of the terminal antenna unit 51 according to the first embodiment of the invention. As illustrated in FIG. 7, the terminal antenna unit 51 is composed by including a wireless reception unit 51-1, a wireless transmission unit 51-2, a control information separation unit 51-3, a reference signal separation unit 51-5, and an antenna 51-6. A transmission signal transmitted by the base station apparatus 1 is received first by the antenna 51-6, and then input to the wireless reception unit 51-1. The wireless reception unit 51-1 converts the input signal into a signal with a baseband to input the resultant signal to the control information separation unit 51-3.

The control information separation unit 51-3 separates the signal transmitted by the base station apparatus 1 into a signal, which is directly related to data transmission, and control information. In the present embodiment, the signal which is directly related to data transmission is the transmission signal vector s, the CSI-RS, and the DMRS, which are transmitted by the base station apparatus 1. On the other hand, information associated with the covariance matrix Pₓ of the transmission code vector x corresponds to the control information. The control information separation unit 51-3 outputs the information associated with the covariance matrix Pₓ of the transmission code vector x to the channel estimation unit 53. In addition, the control information separation unit 51-3 outputs the signal which is directly related to data transmission to the reference signal separation unit 51-5.

The reference signal separation unit 51-5 separates the input signal into a data signal component, a CSI-RS component, and a DMRS component. The reference signal separation unit 51-5 inputs the data signal component to the channel equalization unit 57 and inputs the CSI-RS and the DMRS to the channel estimation unit 53. In the case where the method in the present embodiment is applied to OFDM transmission, the signal processing in the terminal antenna unit 51 is to be performed basically on each subcarrier.

The channel estimation unit 53 performs channel estimation based on the input CSI-RS and DMRS which are known reference signals. First, channel estimation using the CSI-RS will be described.

Since the CSI-RS is transmitted with no precoding applied, a channel matrix h given by the formula (1) is able to be estimated. Since the CSI-RS is normally multiplexed periodically with a radio resource, channel information of all the radio resources is not able to be estimated directly. However, if the CSI-RS is transmitted in a time interval and a frequency interval, which satisfy a sampling theorem, the terminal apparatus 2 is able to estimate channel information of all the radio resources by appropriate interpolation. This is similar also to the DMRS described below. A specific method for estimating a channel is not particularly limited. For example, the channel estimation unit 53 may apply inverse modulation to the received CSI-RS based on a known reference signal sequence used for the CSI-RS.

The channel estimation unit 53 of the terminal apparatus 2 inputs channel information h, which is estimated based on the CSI-RS, to the feedback information generation unit 55. The feedback information generation unit 55 generates information to be fed back to the base station apparatus 1 in accordance with the input channel information and a format of the channel information to be fed back by the terminal apparatus 2. In the present embodiment, an assumed method of feedback has been described, so that the description thereof will be omitted.

Next, the channel estimation unit 53 performs channel estimation based on the DMRS, which will be described below, and signal processing in the channel equalization unit 57 will be described first. A reception signal vector r=[r₁, . . . , r_{Nr-1}]^{T}, which is input to the channel equalization unit 57, is given by a formula (3). Note that, description of a long-interval fluctuation component such as path loss between the base station apparatus 1 and the terminal apparatus 2 will be omitted. Further, the power normalization coefficient β is set as being included in the linear filter W, and the description thereof will be therefore omitted.

$$\begin{matrix}[ Expression 3 ] & \\ r = ( \begin{matrix}{r}_{1} \\ ⋮ \\ {r}_{{N}_{r} - 1}\end{matrix} ) = hWx + η & ( 3 )\end{matrix}$$

Here, η is a noise vector having, as elements, noise applied to signals received by each receive antenna of the terminal apparatus 2. Note that, interference power such as inter-cell interference is also included in the noise. The channel equalization unit 57 performs channel equalization (spatial separation processing) for detecting a desired signal vector x from the reception signal vector r given by the formula (3). In the present embodiment, the channel equalization unit 57 performs spatial separation processing based on a linear filter calculated based on an MMSE criterion.

An equalization output xₒ corresponding to the desired signal vector x is expressed by xₒ=Wᵣx. Here, Wᵣ is weight which minimizes a mean square error between xₒ and x. Wᵣ is given by a formula (4).

[Expression 4]

Wᵣ=(hWPₓ)^{H}((hWPₓ^{1/2})(hWPₓ^{1/2})^{H}+σ²I_{N}_{ᵣ})⁻¹ (4)

Here, σ² is average power of noise received by each receive antenna of the terminal apparatus 2. It is found from the formula (4) that the covariance matrix Pₓ of the transmission code vector x, an equalization channel matrix hW expressed by a product of the channel information h and the linear filter W which is used in the base station apparatus 1, and the average power of noise are required to calculate an MMSE reception filter Wᵣ.

Here, signal processing for the DMRS in the channel estimation unit 53 will be described. The channel estimation unit 53 estimates information, which is required for the MMSE filter given by the formula (4), based on the DMRS. In the present embodiment, the base station apparatus 1 notifies the terminal apparatus 2 of information associated with Pₓ. Thus, the channel estimation unit 53 is able to estimate Pₓ based on the information associated with Pₓ.

Further, in the present embodiment, the precoding unit 27 of the base station apparatus 1 multiplies the DMRS by the linear filter W which is the same as the linear filter W multiplied by the data signal. Thus, the channel estimation unit 53 is able to estimate hW by applying inverse modulation for the received DMRS based on the known reference signal sequence used for the DMRS.

Note that, in the present embodiment, the base station apparatus 1 transmits a plurality of DMRSs by using radio resources which are orthogonal to one another. Therefore, a value that is able to be estimated by the channel estimation unit 53 based on each of the DMRSs is a part of information of hW. For example, the channel estimation unit 53 is able to estimate a vector in an m-th column of hW by inverse modulation for pₘ which is the received m-th DMRS. The channel estimation unit 53 is able to estimate hW by combining all the information estimated by inverse modulation for the DMRSs associated with each data signal.

Finally, the channel estimation unit 53 obtains the average power of noise σ², and a method for obtaining the average power of noise is not limited. For example, the channel estimation unit 53 is able to calculate a replica of the DMRS received by the terminal apparatus 2, by multiplying a channel estimation value obtained based on the DMRS by the known reference signal sequence again. The channel estimation unit 53 may set average power of the signal obtained by subtracting the replica of the DMRS from the received DMRS signal as the average power of noise. In the case where a radio resource in which no signal is transmitted is defined in advance between the base station apparatus 1 and the terminal apparatus 2, the channel estimation unit 53 may set the average power of this radio resource as the average power of noise.

The channel estimation unit 53 outputs estimation values of the covariance matrix Pₓ, the equalization channel matrix hW, and the average power of noise σ² to the channel equalization unit 57.

Based on the information input by the channel estimation unit 53, the channel equalization unit 57 calculates a linear filter Wᵣ based on the MMSE criterion, which is given by the formula (4), and multiplies the reception signal vector r by the result to obtain a soft-estimation value xₒ of the transmission code vector x.

The channel equalization unit 57 further applies modulo operation to the soft-estimation value xₒ, removes the perturbation vector added to the soft-estimation value xₒ, and calculates a soft-estimation value dₒ for a transmission data vector d. The modulo operation for the soft-estimation value xₒ is given by a formula (5).

$$\begin{matrix}[ Expression 5 ] & \\ \{ \begin{matrix}{mod}_{2 δ} ( {x}_{o} ) = {x}_{o} = 2 δ \cdot floor ( {x}_{o} / 2 δ + ( 1 + j ) / 2 ) = {x}_{o} + 2 δ {z}_{o} \\ {z}_{o} = - floor ( {x}_{o} / 2 δ + ( 1 + j ) / 2 )\end{matrix} & ( 5 )\end{matrix}$$

Here, a value same as that of the modulo width used in the perturbation vector search unit 27-2 of the base station apparatus 1 needs to be used for δ. The channel equalization unit 57 outputs an output of the modulo operation for the soft-estimation value xₒ to the de-mapping unit 59. Note that, when channel decoding in consideration of the perturbation term added to the data signal is allowed in a channel decoding unit 63 described below, the modulo operation in the channel equalization unit 57 is not required.

The de-mapping unit 59 extracts only data of a radio resource, in which data addressed to the terminal apparatus itself is transmitted, from the signal input by the channel equalization unit 57 and outputs extracted data to the data demodulation unit 61. Note that, it may be configured such that an output of the terminal antenna unit 51 is directly input to the de-mapping unit 59 and an output of the de-mapping unit 59 is input to the channel equalization unit 57.

The data demodulation unit 61 performs data demodulation on the input signal to output the resultant signal to the channel decoding unit 63. By performing channel decoding for the input signal, the channel decoding unit 63 acquires a transmission data sequence transmitted by the base station apparatus 1 to the terminal apparatus 2.

Note that, the channel decoding unit 63 needs to obtain likelihood or a log likelihood ratio of the input signal. In the case where the channel equalization unit 57 does not perform the modulo operation, the channel decoding unit 63 obtains the log likelihood ratio by considering influence of the perturbation vector.

With the method which has been described above, in a wireless communication system for performing SU-MIMO transmission in which the base station apparatus 1 transmits transmission signals to the terminal apparatus 2 by performing spatial multiplexing with nonlinear precoding, the terminal apparatus 2 is able to perform antenna combining based on the MMSE criterion for the signals received by a plurality of receive antennas. Thus, the terminal apparatus 2 is able to suppress inter-antenna interference with high efficiency, so that high reception quality is able to be achieved. This makes it possible to contribute to improvement in frequency efficiency of the wireless communication system.

### 2. Second Embodiment

The first embodiment has been intended for SU-MIMO transmission. A second embodiment is intended for a wireless communication system for performing MU-MIMO transmission.

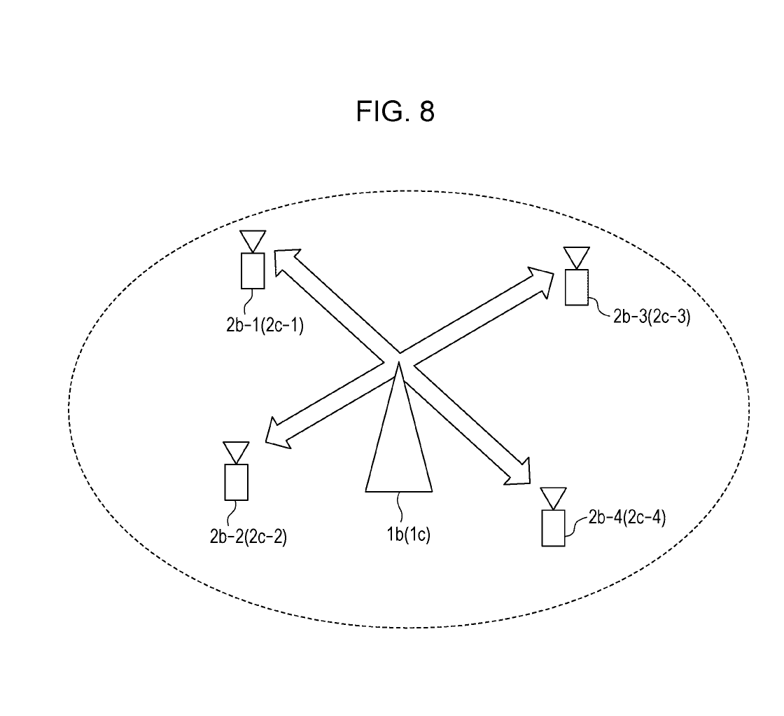

FIG. 8 is an illustration of one schematic example of the wireless communication system according to the second embodiment of the invention. The second embodiment is intended for MU-MIMO transmission in which U terminal apparatuses 2b (four terminal apparatuses 2b-1 to 2b-4 in FIG. 1) each having Nᵣ receive antennas are connected to a base station apparatus 1b which has Nₜ transmit antennas and is capable of performing nonlinear precoding. R pieces of data are simultaneously transmitted to each of the terminal apparatuses 2b and U×R≦Nₜ and R<Nᵣ.

Next, a summary of CSI and feedback of the CSI between the base station apparatus 1b and the plurality of terminal apparatuses 2b will be described. Complex channel gains between an n-th transmit antenna (n=1 to Nₜ) and an m-th receive antenna (m=1 to Nᵣ) of a u-th terminal apparatus 2b-u (u=1 to U) are set as A channel matrix hᵤ of the u-th terminal apparatus 2-u is defined as the formula (1) similarly to the first embodiment.

Each of the terminal apparatuses 2b notifies the base station apparatus 1b of CSI similarly to the first embodiment. The CSI which is notified by the u-th terminal apparatus 2b-u to the base station apparatus 1b is defined as h_{FB,u}. A calculation method and a notification method of h_{FB} in each of the terminal apparatuses 2b are similar to those of the first embodiment, so that the description thereof will be omitted. Note that, as described also in the first embodiment, various methods are considered for the calculation method and the notification method of h_{FB} in each of the terminal apparatuses 2b. In the following description, similarly to the first embodiment, each of the terminal apparatuses 2b directly quantizes the complex channel gains observed by the R receive antennas which are randomly selected from the Nᵣ receive antennas to notify the result to the base station apparatus 1. That is, h_{FB,u} is a channel matrix of R×Nₜ.

Note that, each of the terminal apparatuses 2b may use mutually different calculation methods and notification methods. Control may be performed so that the base station apparatus 1b explicitly instructs a calculation method and a notification method to each of the terminal apparatuses 2b and each of the terminal apparatuses 2b notifies the base station apparatus 1b of channel information in accordance with the instruction of the base station apparatus 1b. It may be configured such that each of the terminal apparatuses 2b explicitly notifies the base station apparatus 1 of the methods that the terminal apparatus has used for calculating and notifying feedback information.

In the base station apparatus 1b, a matrix H_{FB}=[h_{FB,1}; h_{FB,2}; . . . ; h_{FB,U}], which is generated with arrayed CSI notified from each of the terminal apparatuses 2b, is regarded as a channel matrix and signal processing such as precoding described below is performed.

[2.1 Base Station Apparatus 1b]

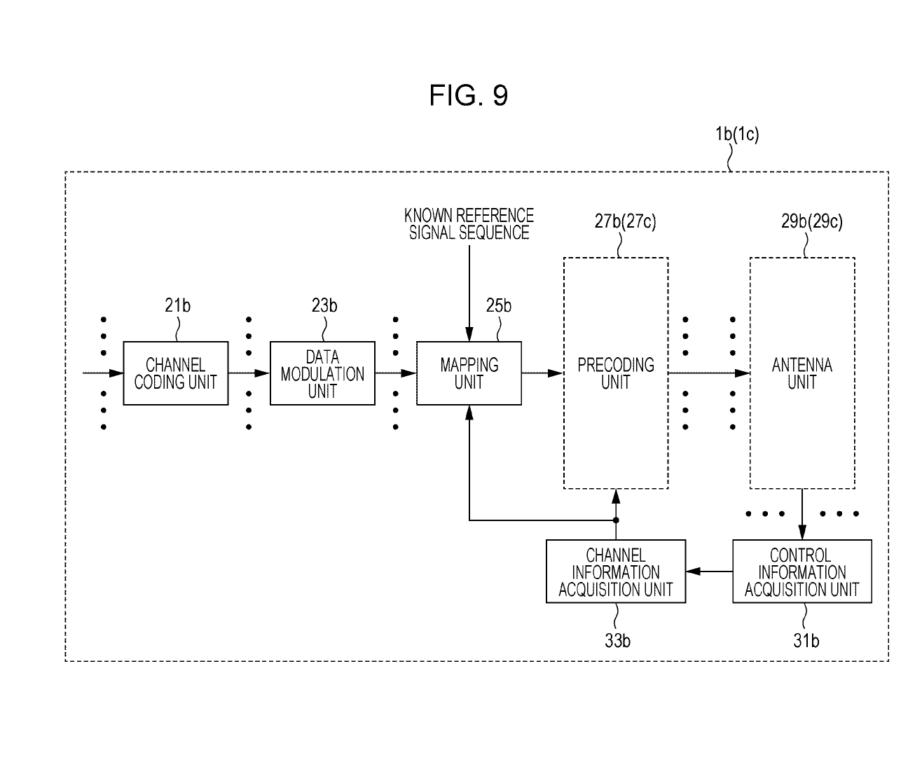

FIG. 9 is a block diagram illustrating one configuration example of the base station apparatus 1b according to the second embodiment of the invention. The base station apparatus 1b is almost similar to the base station apparatus 1, but in the second embodiment, transmits data signals addressed to the U terminal apparatuses 2 by performing spatial multiplexing, so that a channel coding unit 21b and a data modulation unit 23b apply channel coding and data modulation to each data addressed to each of the terminal apparatuses 2b. An operation of the base station apparatus 1b will be described below by focusing on a point different from the base station apparatus 1.

Fist, a control information acquisition unit 31b acquires control information notified from the plurality of terminal apparatuses 2b which are connected, and outputs information associated with channel information among the control information to a channel information acquisition unit 33b. The channel information acquisition unit 33b acquires {h_{FB,u}; u=1 to U} notified from the plurality of terminal apparatuses 2b based on the information input from the control information acquisition unit 31b, and further calculates H_{FB}. The channel information acquisition unit 33b outputs H_{FB} to a precoding unit 27b.

The channel coding unit 21b performs channel coding for each of transmission data sequences addressed to each of the terminal apparatuses 2b and inputs the result to the data modulation unit 23b. The data modulation unit 23b applies digital data modulation to each of bit sequences, which are input, to input the modulation result to the mapping unit 25b.

The mapping unit 25b first performs mapping of data signals addressed to each of the terminal apparatuses 2b to radio resources. Selection of the terminal apparatus 2b to be subjected to spatial multiplexing by the base station apparatus 1b and selection of the radio resource in which a signal is to be transmitted are performed based on reception quality and channel information notified from each of the terminal apparatuses 2b to the base station apparatus 1b.

In the following, it is assumed that the mapping unit 25b spatially multiplexes data signals addressed from the first terminal apparatus 2b-1 to the U-th terminal apparatus 2b-U at all times. The mapping unit 25 performs mapping of a data signal vector dᵤ (“u” is omitted and not described in the first embodiment) addressed to one terminal apparatus 2. On the other hand, the mapping unit 25b performs mapping of d=[d₁; d₂; . . . ; dᵤ], which is a column vector with (U×R) rows, in which data signal vectors addressed to each of the terminal apparatuses 2 are arrayed.

Next, signal processing for DMRSs by the mapping unit 25b will be described. The mapping unit 25 performs mapping of R DMRSs addressed to one terminal apparatus 2 for radio resources which are orthogonal to one another. The mapping unit 25b performs mapping of DMRSs corresponding to R data signals addressed to each of the terminal apparatuses 2b for radio resources which are orthogonal to one another. That is, the mapping unit 25b performs mapping of U×R pieces of DMRSs for radio resources which are orthogonal to one another. The mapping unit 25b inputs the data signals subjected to mapping, and the like to the precoding unit 27b.

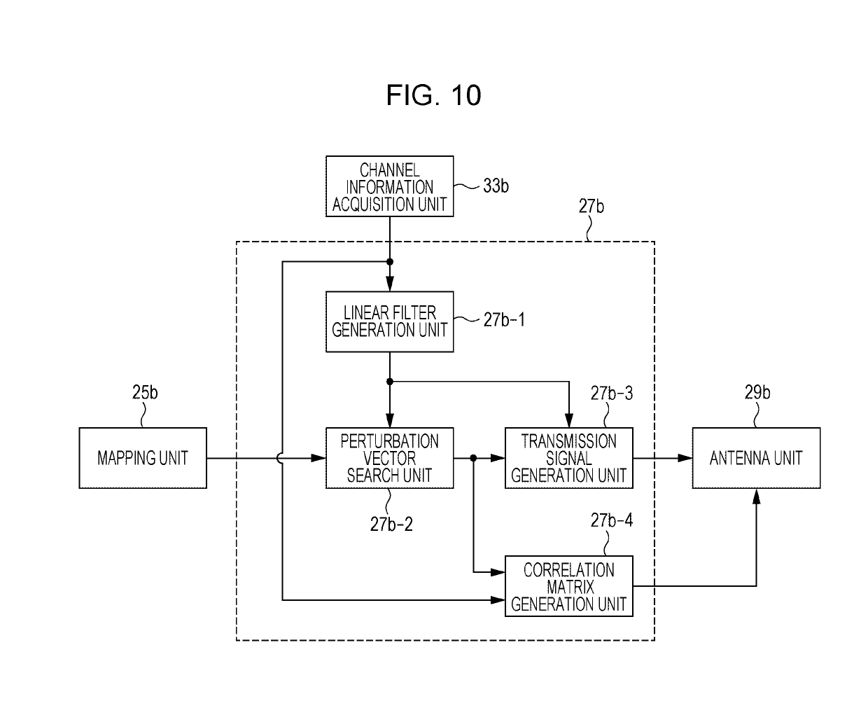

FIG. 10 is a block diagram illustrating one example of a configuration of the precoding unit 27b according to the second embodiment. Signal processing in the precoding unit 27b is almost similar to that of the precoding unit 27. Difference is recognized in that the precoding unit 27 applies precoding processing to dᵤ based on h_{FB}, whereas the precoding unit 27b applies precoding to d based on H_{FB}.

A linear filter generated by a linear filter generation unit 27b-1 is W=H_{FB}^{H}(H_{FB}H_{FB}^{H}+αI_{RU})⁻¹. Here, W is a matrix with Nₜ rows and (U×R) columns, and is able to be expressed as W=[w₁, w₂, . . . , wᵤ], in which wᵤ denotes a matrix with Nₜ rows and R columns, by which R data signals addressed to the u-th terminal apparatus 2b-u are multiplied. That is, wᵤ is able to be regarded as a linear filter corresponding to W generated by the linear filter generation unit 27-1 in the first embodiment. Any configuration may be given as α similarly to the first embodiment. Note that, in the case where the liner filter generation unit 27b-1 configures α as an inverse of a reception-signal-to-interference-plus-noise power ratio γᵤ observed in each of the terminal apparatuses 2b, γᵤ naturally has different values between each of the terminal apparatuses 2b, so that it may be set that W=H_{FB}^{H}(H_{FB}H_{FB}^{H}+diag{γ₁⁻¹I_{R}, γ₂⁻¹I_{R}, . . . , γ₂⁻¹I_{R}}).

A perturbation vector search unit 27b-2 also performs similar signal processing to that of the perturbation vector search unit 27-2, and searches for a perturbation vector by solving a minimization problem given by substituting h_{FB} of the formula (2) with H_{FB}. The perturbation vector z is given by [z₁; z₂; . . . ; zᵤ], and the transmission code vector x calculated by the perturbation vector search unit 27b-2 is a column vector having R×U pieces of elements, which is expressed by x=d+2δz. As to signal processing in a correlation matrix generation unit 27b-4 as well, obtaining Pₓ based on H_{FB} and x is similar to that of the first embodiment, so that the description thereof will be omitted. Signal processing in a transmission signal generation unit 27b-3 is also similar to that of the first embodiment, so that the description thereof will be omitted.

Signal processing of the precoding unit 27b when DMRSs are input is also similar to that of the first embodiment. That is, with respect to the DMRSs, the precoding unit 27b does not perform addition of a perturbation vector but applies precoding for performing multiplication only by the linear filter W.

The precoding unit 27b outputs the transmission signal vector s generated by the transmission signal generation unit 27b-3 and the covariance matrix Pₓ of the transmission code vector x, which is generated by the correlation matrix generation unit 27b-4, to an antenna unit 29b.

A configuration and signal processing in the antenna unit 29b may be similar to those of the antenna unit 29 in the first embodiment, so that the detailed description thereof will be omitted. Note that, as to information associated with the covariance matrix P. calculated by the control information multiplexing unit 29-5, the control information multiplexing unit 29-5 may perform control so as to notify each of the terminal apparatuses 2b of the information with other control information, similarly to the first embodiment. However, since information of Rₓ is shared in all the terminal apparatuses 2b which are spatially multiplexed in the radio resources, the control information multiplexing unit 29-5 may notify the information associated with P. with a control information channel shared between all the terminal apparatuses 2b.

[2.2 Terminal Apparatus 2b]

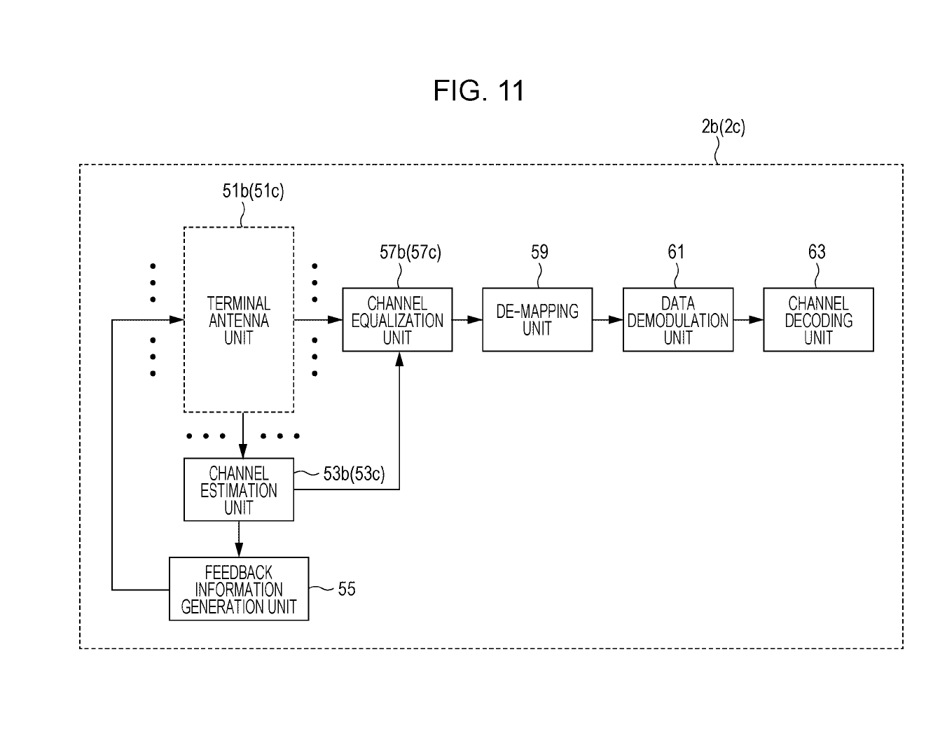

FIG. 11 is a block diagram illustrating one example of a configuration of the terminal apparatus 2b according to the second embodiment of the invention. An apparatus configuration of the terminal apparatus 2b is almost similar to that of the terminal apparatus 2. However, signal processing in a reference signal separation unit 51b-5 (which is omitted and not illustrated in the figure) included in a terminal antenna unit 51b, a channel estimation unit 53b, and a channel equalization unit 57b is different from that of the first embodiment.

Among signals (data signals, DMRSs, and CSI-RSs) directly related to data transmission, which are input from the control information separation unit 51-3, the reference signal separation unit 51b-5 outputs the data signals to the channel equalization unit 57b, and outputs the DMRSs and the CSI-RSs to the channel estimation unit 53b. Here, as to the DMRSs, the reference signal separation unit 51b-5 outputs not only DMRSs associated with data signals addressed to the terminal apparatus itself, but also DMRSs associated with data signals addressed to other terminal apparatuses 2b to the channel estimation unit 53b. Thus, the terminal apparatus 2b needs to recognize the radio resource in which the DMRSs associated with the data signals addressed to other terminal apparatuses 2b are transmitted, and the known reference signal sequence used for the DMRSs. In the present embodiment, for example, information of the known reference signal sequence used for the DMRSs addressed to other terminal apparatuses 2b is notified in advance to each of the terminal apparatuses 2b by the base station apparatus 1b.

Next, signal processing in the channel estimation unit 53b will be described. The CSI-RSs, and the DMRSs which also include the DMRSs addressed to other terminal apparatuses 2b are input to the channel estimation unit 53b. Signal processing for the CSI-RSs is similar to that of the first embodiment, so that the description thereof will be omitted.

The channel estimation unit 53b performs channel estimation based on the DMRSs which also include the DMRSs addressed to other terminal apparatuses 2b. For example, a channel estimation value which is able to be estimated by the first terminal apparatus 2b-1 based on the DMRSs associated with each of R data signals addressed to the terminal apparatus itself is h₁w₁. This is similar to the signal processing in the channel estimation unit 53.

The first terminal apparatus 2b-1 is able to further estimate h₁w₂ based on the DMRSs associated with each of the R data signals which have been transmitted to the second terminal apparatus 2b-2. Similarly, the first terminal apparatus 2b-1 performs channel estimation by using the DMRSs which have been transmitted to other terminal apparatuses 2b, and the channel estimation unit 53b is able to estimate h₁w₁, h₁w₂, . . . h₁w_{U}.

That is, the channel estimation unit 53b of the u-th terminal apparatus 2b-u is able to estimate h_{U}W by channel estimation values estimated based on each of the DMRSs. The channel estimation unit 53b outputs h_{U}W to the channel equalization unit 57b.

Based on the information input by the channel estimation unit 53b, the channel equalization unit 57b calculates the linear filter Wᵣ based on the MMSE criterion similarly to the first embodiment. The linear filter Wᵣ is given by the formula (4) similarly to the first embodiment. However, the linear filter Wᵣ which is calculated by the channel equalization unit 57b of the second embodiment is a matrix with U×R rows and Nᵣ columns. That is, Wᵣ which is calculated by the channel equalization unit 57b is the linear filter by which not only the data signals addressed to the terminal apparatus itself but also the data signals addressed to other terminal apparatuses 2b are able to be demodulated.

The channel equalization unit 57b multiplies the reception signal vector r by the calculated linear filter Wᵣ, and then extracts only outputs of equalization associated with the data signals addressed to the terminal apparatus itself. In the case where the channel estimation unit 53b calculates hᵤW as hᵤW=[h₁w₁, h₁w₂, . . . , h₁W_{U}], the first terminal apparatus 2b-1 may extract only an output of equalization corresponding to a matrix from a first row to an R-th row of Wᵣ among the outputs of equalization. The channel equalization unit 57b applies the modulo operation to the extracted output of equalization and then outputs the result to the data demodulation unit 61.

Not that, although description is not provided in the present embodiment, in the case where interference cancellers such as successive interference canceller (SIC) and parallel interference canceller (PIC) are used in combination in the channel equalization unit 57b, needless to say, the channel equalization unit 57b needs to demodulate not only the data signals addressed to the terminal apparatus itself but also the data signals addressed to other terminal apparatuses 2.

The present embodiment is intended for MU-MIMO transmission. According to the invention, each of the terminal apparatuses 2b is able to perform MMSE receive antenna combining also at a time of MU-MIMO transmission, and is able to suppress not only inter-antenna interference but also inter-user interference with high efficiency similarly to the first embodiment. Accordingly, high transmission performance is able to be realized, thus making it possible to contribute to improvement in frequency efficiency of the wireless communication system.

### 3. Third Embodiment

In the first and second embodiments, the base station apparatus 1(1b) explicitly notifies the terminal apparatus 2(2b) which is connected of the covariance matrix Pₓ of the transmission code vector x as control information. However, the notification of the covariance matrix Pₓ as control information increases overhead. A third embodiment is intended for a system in which the covariance matrix Pₓ is not notified explicitly.

Similarly to the second embodiment, the third embodiment is intended for MU-MIMO transmission in which U terminal apparatuses 2c each having Nᵣ receive antennas are connected to a base station apparatus 1c having Nₜ transmit antennas. As illustrated in FIG. 8, a wireless communication system intended for in the third embodiment is different from the wireless communication system intended for in the second embodiment only in terms of a constituent device. An apparatus configuration of the base station apparatus 1c is almost similar to that of the base station apparatus 1b of the second embodiment illustrated in FIG. 9. A difference between the base station apparatus 1c and the base station apparatus 1b lies in the precoding unit 27 and the antenna unit 29.

[3.1 Base Station Apparatus 1c]

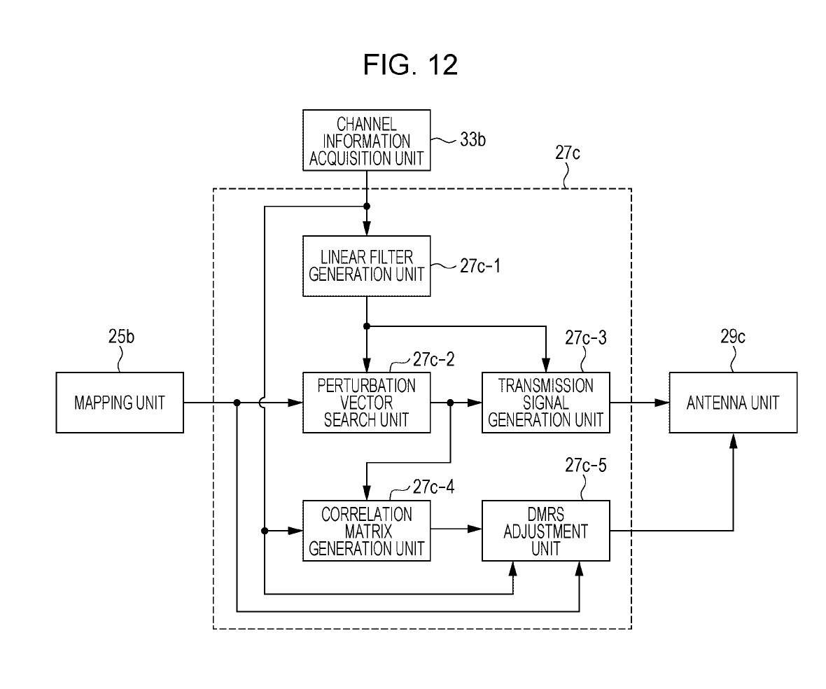

FIG. 12 is a block diagram illustrating one example of a device configuration of a precoding unit 27c according to the third embodiment of the invention. The precoding unit 27c is almost similar to the precoding unit 27b, but a DMRS adjustment unit 27c-5 is added. The DMRS adjustment unit 27c-5 is a device that performs signal processing for the DMRSs input from the mapping unit 25b. Signal processing associated with data signals of other constituent devices except for the DMRS adjustment unit 27c-5 is similar to that of the second embodiment, so that the description thereof will be omitted. Note that, though the transmission signal generation unit 27b-3 also performs the signal processing for DMRSs in the precoding unit 27b, a transmission signal generation unit 27c-3 does not perform the signal processing for DMRSs in the precoding unit 27c.

The signal processing in the DMRS adjustment unit 27c-5 will be described. A linear filter W calculated by a linear filter generation unit 27c-1, a covariance matrix Pₓ calculated by a correlation matrix generation unit 27c-4, and DMRSs are input to the DMRS adjustment unit 27c-5.

Description will be given below by setting that two terminal apparatuses 2c are connected to the base station apparatus 1c and further setting R=2, for simplification. In this case, since there are four data signals to be spatially multiplexed by the base station apparatus 1c, the base station apparatus 1c needs to transmit four DMRSs (p₁, p₂, p₃, p₄) by using four radio resources which are orthogonal to one another. In the following, these DMRSs are expressed by using one matrix Q. The DMRS matrix Q is given by a formula (6).

$$\begin{matrix}[ Expression 6 ] & \\ Q = ( \begin{matrix}{p}_{1} & 0 & 0 & 0 \\ 0 & {p}_{2} & 0 & 0 \\ 0 & 0 & {p}_{3} & 0 \\ 0 & 0 & 0 & {p}_{4}\end{matrix} ) & ( 6 )\end{matrix}$$

Here, respective columns of Q indicate the DMRSs transmitted by the radio resources which are orthogonal to one another. For example, the respective columns of Q may be associated with consecutive times or may be associated with orthogonal times, frequencies and codes.

The transmission signal generation unit 27-3 (27b-3) of the precoding unit 27 (27b) multiplies Q given by the formula (6) by the linear filter W and adjusts transmit power, followed by outputting to the antenna unit 29 (29b). The precoding unit 27c applies signal processing to the DMRS signals so that each terminal apparatus 2c is able to calculate an MMSE reception filter, which is given by the formula (4), with channel estimation values which are able to be estimated based on the DMRSs.

In the third embodiment, the base station apparatus 1c transmits the DMRS matrix Q, which is given by the formula (6), at least twice. When there are four DMRSs included in Q, the base station apparatus 1c is to transmit the DMRSs by using eight radio resources in total, which are orthogonal to one another. The DMRS matrix Q which is transmitted twice by the base station apparatus 1c called a first DMRS and a second DMRS.

The DMRS adjustment unit 27c-5 calculates WPₓ^{1/2}Q as the first DMRS. The DMRS adjustment unit 27c-5 then calculates WPₓQ as the second DMRS, and performs adjustment of transmit power for the first and second DMRSs. The adjustment (normalization) of transmit power performed by the DMRS adjustment unit 27c-5 for the first and second DMRSs may be similar to the adjustment of transmit power applied by the transmission signal generation unit 27-3 (27b-3) to the DMRSs. The DMRS adjustment unit 27c-5 outputs the first and second DMRSs to an antenna unit 29c.

Note that, a method for calculating Pₓ^{1/2} by the DMRS adjustment unit 27c-5 is not limited. For example, the DMRS adjustment unit 27c-5 may use a lower triangular matrix L obtained by applying Cholesky decomposition to Pₓ as Pₓ^{1/2}. Since Pₓ is an Hermitian matrix, the DMRS adjustment unit 27c-5 may apply unique value decomposition as Pₓ=UΛU^{H} and then calculate UΛ^{1/2} as Pₓ^{1/2}. Here, Λ is a diagonal matrix, and U is a Unitary matrix.

The signal processing in other constituent devices at the base station apparatus 1c is similar to that of the base station apparatus 1b, so that the description thereof will be omitted.

[3.2 Terminal Apparatus 2c]

A configuration of the terminal apparatus 2c in the third embodiment is almost similar to that of the terminal apparatus 2b illustrated in FIG. 11. However, the terminal apparatus 2c includes a channel estimation unit 53c, a channel equalization unit 57c, and a terminal antenna unit 51c instead of the channel estimation unit 53b, the channel equalization unit 57b, and the terminal antenna unit 51b.

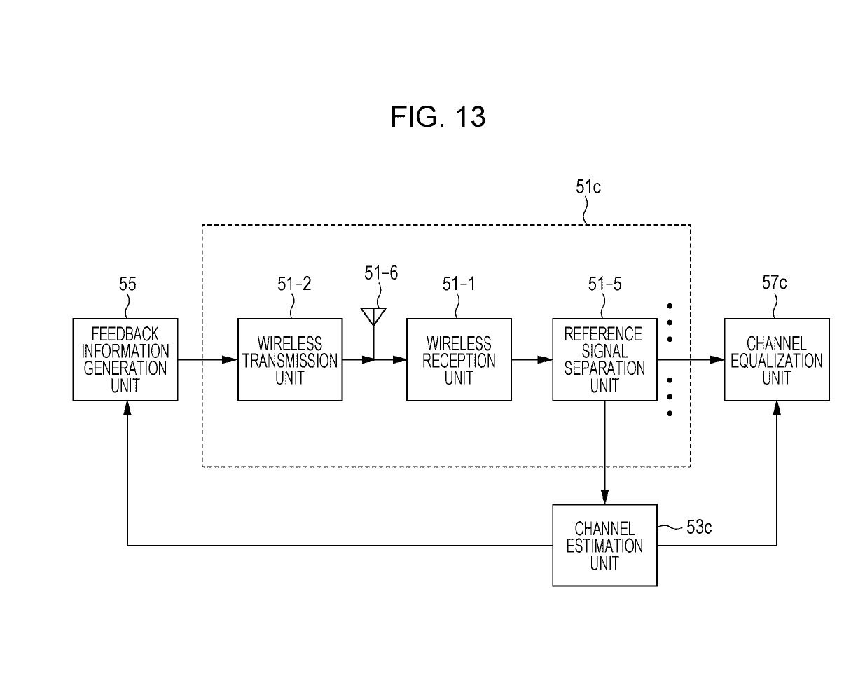

FIG. 13 is a block diagram illustrating a configuration of the terminal antenna unit 51c according to the third embodiment. Differently from the terminal antenna unit 51b, the terminal antenna unit 51c has a configuration, in which the control information separation unit 51-3 is not included. This is because the base station apparatus 1c does not notify each of the terminal apparatuses 2c of information associated with the covariance matrix Pₓ of the transmission code vector x. Note that, as described also in the second embodiment, in the case where control information for notifying a modulation method, a coding rate and the like is notified from the base station apparatus 1c to each of the terminal apparatuses 2c, the base station apparatus 1c needs the control information separation unit 51-3. Note that, the signal processing in other constituent devices is similar to that of the terminal antenna unit 51b, so that the description thereof will be omitted.

Signal processing for CSI-RSs and a method for estimating average power of noise in the channel estimation unit 53c are similar to those of the channel estimation unit 53b, so that the description thereof will be omitted. The channel estimation unit 53c performs channel estimation for each of the first DMRS and the second DMRS, which are transmitted from the base station apparatus 1c.

Signal processing applied by the channel estimation unit 53c to the first DMRS and the second DMRS is the same as the signal processing applied by the channel estimation unit 53b to the DMRSs. The channel estimation unit 53c is able to estimate hWPₓ^{1/2} as a first equalization channel estimation value based on the first DMRS. On the other hand, the channel estimation unit 53c is able to estimate hWPₓ as a second equalization channel estimation value based on the second DMRS. By using the first and second equalization channel estimation values and average power of noise, each of the terminal apparatuses 2c is able to calculate the MMSE reception filter given by the formula (4).

The channel estimation unit 53c outputs the first equalization channel estimation value and the second equalization channel estimation value to the channel equalization unit 57c.

Based on the first and second equalization channel estimation values input from the channel estimation unit 53c, and the average power of noise, the channel equalization unit 57c calculates the MMSE reception filter given by the formula (4). The MMSE reception filter is given by a product of an adjugate matrix of hWPₓ and an inverse matrix of ((hWPₓ^{1/2})(hWPₓ^{1/2})^{H}+σ²I_{Nr}) The channel equalization unit 57c is able to calculate the adjugate matrix of hWPₓ based on the second equalization channel estimation value. The channel equalization unit 57c is able to calculate (hWPₓ^{1/2})(hWPₓ^{1/2})^{H} based on the first equalization channel estimation value.

The channel equalization unit 57c performs spatial separation processing for multiplying the data signals input from the reference signal separation unit 51-5 by the MMSE reception filter. Note that, other signal processing in the terminal apparatus 2c is similar to that of the terminal apparatus 2b, so that the description thereof will be omitted.

Note that, the third embodiment is intended for the wireless communication system in which nonlinear MU-MIMO transmission is performed, similarly to the second embodiment. However, the method of the present embodiment is also applicable to nonlinear SU-MIMO transmission which is intended for in the first embodiment.

In the wireless communication system which is intended for in the third embodiment, a wireless communication system is intended for that the base station apparatus 1c does not explicitly notify the terminal apparatus 2c of information of the covariance matrix Pₓ which is required when the terminal apparatus 2c calculates the MMSE reception filter, but implicitly notifies the terminal apparatus 2c of it by using the DMRSs. According to the method of the present embodiment, compared to a case where Pₓ is notified from the base station apparatus 1c to the terminal apparatus 2c as control information, it is possible to suppress overhead associated with the notification of the control information, thus making it possible to contribute to improvement in frequency efficiency of the wireless communication system.

### Modified Example 1

According to the method which has been described as the third embodiment, the DMRS matrix Q needs to be transmitted at least twice in order for the base station apparatus 1c to notify the terminal apparatus 2c of the covariance matrix Pₓ of the transmission code vector x. Since the DMRS matrix Q is a redundancy signal, such control increases overhead associated with transmission of the DMRSs. A wireless communication system in which the base station apparatus 1c notifies the terminal apparatus 1c of Pₓ by single transmission of the DMRSs is intended for in the present modified example.

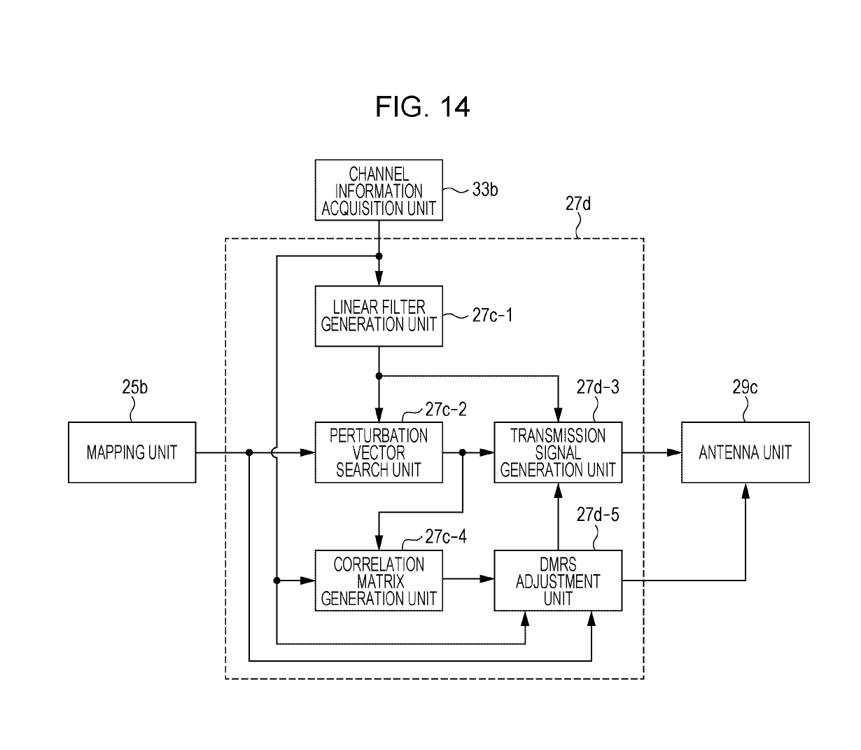

In the present modified example, the base station apparatus 1c includes a precoding unit 27d instead of the precoding unit 27c. FIG. 14 is a block diagram illustrating one example of a configuration of the precoding unit 27d in the present modified example. In the precoding unit 27d, compared to the precoding unit 27c, a transmission signal generation unit 27d-3 and a DMRS adjustment unit 27d-5 are used instead of the transmission signal generation unit 27c-3 and the DMRS adjustment unit 27c-5, respectively.

In the present modified example, the DMRS adjustment unit 27d-5 does not calculate the second DMRS. The DMRS adjustment unit 27d-5 calculate only WPₓ^{1/2}Q which is the first DMRS, and outputs the WPₓ^{1/2}Q to the antenna unit 29c. The DMRS adjustment unit 27d-5 then outputs Pₓ^{1/2} to the transmission signal generation unit 27d-3.

The transmission signal generation unit 27d-3 calculates a transmission signal vector s. Here, while the transmission signal vector s generated by the transmission signal generation unit 27c-3 is given by s=Wx, the transmission signal vector s calculated by the transmission signal generation unit 27d-3 in the present modified example is given by s WPₓ^{1/2}x. Note that, a power normalization term will be omitted to be described. A difference from the third embodiment lies in that the transmission code vector x is multiplied not only by the linear filter W but Pₓ^{1/2}. This is for the terminal apparatus 2c to achieve an effect equal to that of the MMSE reception filter by a reception filter calculated only from the first equalization channel estimation value which is able to be calculated based on the first DMRS.

An apparatus configuration of the terminal apparatus 2c according to the present modified example is similar to that of the third embodiment, but is different in signal processing in the channel estimation unit 53c and the channel equalization unit 57c.

In the present modified example, only the first DMRS is input to the channel estimation unit 53c. Signal processing for the first DMRS by the channel estimation unit 53c in the present modified example is similar to that of the third embodiment. The channel estimation unit 53c is able to estimate hᵤWPₓ^{1/2} based on the first DMRS. The channel estimation unit 53c outputs hᵤWPₓ^{1/2} and average power of noise (an estimation method thereof will be omitted to be described) to the channel equalization unit 57c.

The channel equalization unit 57c calculates a reception filter given by a formula (7) based on the first equalization channel estimation value and the average power of noise, which are input from the channel estimation unit 53c.

[Expression 7]

Wᵣ=(hᵤWPₓ^{1/2})^{H}((hᵤWPₓ^{1/2})(hᵤWPₓ^{1/2})^{H}+σ²I_{N}_{ᵣ})⁻¹ (7)

The channel equalization unit 57c multiplies the data signal input from the reference signal separation unit 51-5 by the reception filter given by the formula (6). The formula (4) and the formula (7) have different formats of the reception filter. In the present modified example, however, since it is configured such that the transmission signal vector s transmitted by the base station apparatus 1c is multiplied by Pₓ^{1/2} in advance, an effect equal to that of the third embodiment is able to be achieved by using the reception filter of the formula (7).

According to the method of the present modified example, since it is possible to reduce the number of times of transmission of the DMRS by the base station apparatus 1c, overhead associated with the transmission of the DMRS is able to be suppressed. Thus, it is possible to contribute to improvement in frequency efficiency of the wireless communication system.

### 4. For all Embodiments

Though the embodiments of the invention have been described in detail above with reference to the drawings, specific configurations are not limited to the embodiments, and a design and the like which are not departed from the gist of the invention are also included in a scope of claims.

Note that, the invention is not limited to the aforementioned embodiments. The base station apparatus 1 (1b, 1c) and the terminal apparatus 2 (2b, 2c) of the invention are not limited to be applied to a terminal apparatus in a cellar system and the like, but, needless to say, are applicable to stationary or unmovable electronic equipment which is installed indoors or outdoors, such as, for example, AV equipment, kitchen equipment, a cleaning/washing machine, air conditioning equipment, office equipment, an automatic vending machine, and other domestic equipment.

A program which is operated in the base station apparatus 1 (1b, 1c) and the terminal apparatus 2 (2b, 2c) related to the invention is a program which controls a CPU and the like (program that causes a computer to function) so as to realize functions of the aforementioned embodiments related to the invention. In addition, information which is handled by the apparatuses is temporarily accumulated in a RAM at the time of processing thereof, and then stored in various ROMs or an HDD, and is read, modified, and written by the CPU as necessary. A recording medium that stores the program may be any of a semiconductor medium (for example, a ROM, a nonvolatile memory card or the like), an optical recording medium (for example, a DVD, an MO, an MD, a CD, a BD or the like) and a magnetic recording medium (for example, a magnetic tape, a flexible disc or the like). Moreover, there is a case where, by executing the loaded program, not only the functions of the embodiments described above are realized, but also by performing processing in cooperation with an operating system, other application programs or the like based on an instruction of the program, the functions of the invention are realized.

In the case of being distributed in the market, the program is able to be stored in a portable recording medium and distributed or be transferred to a server computer connected through a network such as the Internet. In this case, a storage apparatus of the server computer is also included in the invention. A part or all of the base station apparatus 1 (1b, 1c) and the terminal apparatus 2 (2b, 2c) in the embodiments described above may be realized as an LSI which is a typical integrated circuit. Each functional block of the base station apparatus 1 (1b, 1c) and the terminal apparatus 2 (2b, 2c) may be set as an individual processor and a part or all thereof may be integrated into a processor. Further, a method for making into an integrated circuit is not limited to the LSI and a dedicated circuit or a versatile processor may be used for realization. Further, in a case where a technology for making into an integrated circuit in place of the LSI appears with advance of a semiconductor technology, an integrated circuit by this technology may be also used.

### INDUSTRIAL APPLICABILITY

The invention is suitably used for a base station apparatus, a terminal apparatus, a wireless communication system, and an integrated circuit.

### REFERENCE SIGNS LIST

1, 1b, 1c base station apparatus
2, 2-1, 2-2, 2-3, 2-4, 2-u, 2b, 2b-1, 2b-2, 2b-3, 2b-4, 2b-u, 2c, 2c-1, 2c-2, 2c-3, 2c-4, 2c-u terminal apparatus
21, 21b channel coding unit
23, 23b data modulation unit
25, 25b mapping unit
27, 27b, 27c, 27d precoding unit
27-1, 27b-1, 27c-1 linear filter generation unit
27-2, 27b-2, 27c-2 perturbation vector search unit
27-3, 27b-3, 27c-3, 27d-3 transmission signal generation unit
27-4, 27b-4, 27c-4 correlation matrix generation unit
27c-5, 27d-5 DMRS adjustment unit
29, 29b, 29c antenna unit
29-1 wireless transmission unit
29-2 antenna
29-3 wireless reception unit
29-5 control information multiplexing unit
31, 31b control information acquisition unit
33, 33b channel information acquisition unit
51, 51b, 51c terminal antenna unit
51-1 wireless reception unit
51-2 wireless transmission unit
51-3 control information separation unit
51-5 reference signal separation unit
51-6 antenna
53, 53b, 53c channel estimation unit
55 feedback information generation unit
57, 57b, 57c channel equalization unit
59 de-mapping unit
61 data demodulation unit
63 channel decoding unit

1. A base station apparatus that includes a plurality of antennas, applies nonlinear precoding to a plurality of data signals addressed to at least one terminal apparatus, and spatially multiplexes and transmits the data signals, the base station apparatus comprising:
a channel information acquisition unit that acquires channel information between the base station apparatus and the terminal apparatus;
a mapping unit that multiplexes the plurality of data signals addressed to the terminal apparatus, a reference signal used for channel estimation, and a reference signal used for demodulation; and
a precoding unit that applies nonlinear precoding to the plurality of data signals based on the channel information, wherein
the precoding unit includes a perturbation vector search unit that searches for a perturbation vector, which is to be added to the plurality of data signals, based on the channel information and the plurality of data signals, and
a correlation matrix generation unit that calculates a covariance matrix of the plurality of data signals to which the perturbation vector is added.

2. The base station apparatus according to claim 1, wherein the correlation matrix generation unit calculates the covariance matrix based on the channel information.

3. The base station apparatus according to claim 2, further comprising a control information multiplexing unit that multiplexes control information associated with the covariance matrix with a signal to be notified to the terminal apparatus, wherein
the control information multiplexing unit multiplexes the control information with a control channel by which individual control information addressed to the terminal apparatus is notified.

4. The base station apparatus according to claim 2, further comprising a control information multiplexing unit that multiplexes control information associated with the covariance matrix with a signal to be notified to the terminal apparatus, wherein
the control information multiplexing unit multiplexes the control information with a control channel by which common control information addressed to a plurality of terminal apparatuses is notified.

5. The base station apparatus according to claim 2, wherein the precoding unit applies a part of processing of the nonlinear precoding to the reference signal used for demodulation, based on the covariance matrix.

6. The base station apparatus according to claim 5, wherein the precoding unit applies the precoding to the plurality of data signals based on the covariance matrix.

7. A terminal apparatus that receives by a plurality of antennas a plurality of data signals, which are subjected to nonlinear precoding, spatially multiplexed, and transmitted from a base station apparatus, the terminal apparatus comprising:
a channel estimation unit that acquires channel information between the terminal apparatus and the base station apparatus;
a feedback information generation unit that generates control information associated with the channel information; and
a channel equalization unit that performs antenna combining by multiplying the signals received by the plurality of antennas by a liner filter, wherein
the channel equalization unit calculates the linear filter based on a covariance matrix of the plurality of data signals, to which a part of processing of the nonlinear precoding is applied, and the channel information.

8. The terminal apparatus according to claim 7, further comprising a control information separation unit that acquires control information associated with the covariance matrix from the signals transmitted from the base station apparatus.

9. The terminal apparatus according to claim 7, wherein the channel estimation unit estimates equalization channel information between the terminal apparatus and the base station apparatus, which includes information about the nonlinear precoding and the covariance matrix, based on a reference signal used for demodulation transmitted from the base station apparatus, and the channel equalization unit calculates the linear filter based on the equalization channel information.

10-11. (canceled)

12. An integrated circuit that is mounted in a terminal apparatus that receives a plurality of data signals, which are subjected to nonlinear precoding, spatially multiplexed, and transmitted from a base station apparatus, by a plurality of antennas, and that causes the terminal apparatus to exert a plurality of functions, the functions comprising:
a function of acquiring channel information between the terminal apparatus and the base station apparatus;
a function of generating control information associated with the channel information; and
a function of performing antenna combining by multiplying by a liner filter the signals received by the plurality of antennas, wherein
with the function of performing the antenna combining, a plurality of data signals addressed to the terminal apparatus are detected based on a covariance matrix of the plurality of data signals to which a part of processing of the nonlinear precoding is applied, and the channel information.
